(19) United States
(12) Patent Application Publication
(10) Pub. No.: US 2019/0177617 A1
(43) Pub. Date: Jun. 13, 2019

(54) BIMESOGENIC COMPOUNDS AND MESOGENIC MEDIA

(71) Applicant: MERCK PATENT GMBH, Darmstadt (DE)

(72) Inventors: Kevin ADLEM, Bournemouth (GB); Patricia SAXTON, Salisbury (GB); Hassan ARASI, Eastleigh (GB)

(73) Assignee: MERCK PATENT GMBH, Darmstadt (DE)

(21) Appl. No.: 16/301,190

(22) PCT Filed: May 11, 2017
(86) PCT No.: PCT/EP2017/061305

§ 371 Date: Nov. 13, 2018

(30) Foreign Application Priority Data
May 12, 2016 (EP) 16169450.0

(51) Int. Cl. C09K 19/02; C09K 19/28

(52) U.S. Cl. CPC C09K 19/0258; C09K 2019/0444; C09K 19/28

(57) ABSTRACT

The invention relates to bimesogenic compounds of formula I

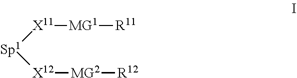

wherein R¹¹, R¹², MG¹, MG², X¹¹, X¹² and Sp¹ have the meaning given in claim 1, to the use of bimesogenic compounds of formula I in liquid crystal media and in particular to flexoelectric liquid crystal devices comprising a liquid crystal medium according to the present invention.

The invention relates to bimesogenic compounds of formula I

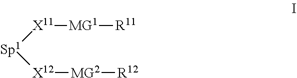

wherein R¹¹, R¹², MG¹, MG², X¹¹, X¹² and Sp¹ have the meanings given herein below, to the use of bimesogenic compounds of formula I in liquid crystal media and in particular to flexoelectric liquid crystal devices comprising the liquid crystal medium according to the present invention.

Liquid Crystal Displays (LCDs) are widely used to display information. LCDs are used for direct view displays as well as for projection type displays. A still widely employed electro-optical mode for displays is the twisted nematic (TN) mode with its various modifications.

Besides this mode, the super twisted nematic (STN) mode and more recently the optically compensated bend (OCB) mode and the electrically controlled birefringence (ECB) mode with their various modifications, such as the vertically aligned nematic (VAN), the patterned ITO vertically aligned nematic (PVA), the polymer stabilized vertically aligned nematic (PSVA) mode and the multi domain vertically aligned nematic (MVA) mode as well as others, have been increasingly employed. All these modes use an electric field which is substantially perpendicular to the substrates, respectively to the liquid crystal layer.

Besides these modes, there are also electro-optical modes employing an electric field substantially parallel to the substrates, respectively the liquid crystal layer, like e.g. the in plane switching (IPS) mode, as disclosed e.g. in DE 40 00 451 and EP 0 588 568, and the fringe field switching (FFS) mode.

Especially the latter mentioned electro-optical modes, which have good viewing angle properties and improved response times, are increasingly used for LCDs for modern desktop monitors and for displays for TV and for multimedia applications and thus are competing with the TN-LCDs.

In addition to these display modes, new modes using cholesteric liquid crystals having a relatively short cholesteric pitch have been proposed for use in displays exploiting the so-called “flexoelectric” effect.

The flexoelectric effect is described inter alia by Chandrasekhar, “Liquid Crystals”, 2nd edition, Cambridge University Press (1992) and P. G. de Gennes et al., “The Physics of Liquid Crystals”, 2nd edition, Oxford Science Publications (1995).

In displays using the flexoelectric effect the cholesteric liquid crystals are typically oriented in the “uniformly lying helix” arrangement (ULH), which gives this display mode its name. Therein a chiral substance which is mixed with a nematic material induces a helical twist transforming the material into a chiral nematic material, which is equivalent to a cholesteric material.

The pitch induced by the chiral substance (P₀) is in a first approximation inversely proportional to the concentration (c) of the chiral material used. The constant of proportionality of this relation is called the helical twisting power (HTP) of the chiral substance and is defined by equation (1)

HTP≡1/(c·P₀) (1)

wherein

c is the concentration of the chiral compound.

The uniformly lying helix texture is realized using a chiral nematic liquid crystal with a short pitch, typically in the range from 0.2 μm to 1 μm, in particular of 0.5 μm or less, and which is unidirectionally aligned with its helical axis parallel to the substrates, e. g. glass plates, of a liquid crystal cell. In this configuration the helical axis of the chiral nematic liquid crystal is equivalent to the optical axis of a birefringent plate.

When an electric field is applied to this configuration normal to the helical axis the optical axis is rotated in the plane of the cell, similar to the director of a ferroelectric liquid crystal rotating in a surface stabilized ferroelectric liquid crystal display. Such displays using the flexoelectric effect may potentially provide benefits in terms of fast response times and grey scale capabilities.

The applied electric field can induce a splay bend structure in the director which is accommodated by a tilt in the optical axis. The angle of the rotation of the axis is in first approximation directly and linearly proportional to the strength of the electric field. The optical effect is best seen when the liquid crystal cell is placed between crossed polarizers with the optical axis in the unpowered state at an angle of 22.5° to the absorption axis of one of the polarizers. This angle of 22.5° is also the ideal angle of rotation of the electric field. Namely as thus, by the inversion of the electric field the optical axis is rotated by 45° and by appropriate selection of the relative orientations of the preferred direction of the axis of the helix, the absorption axis of the polarizer and the direction of the electric field, the optical axis can be switched from parallel to one polarizer to the centre angle between both polarizers. The optimum contrast is then achieved when the total angle of the switching of the optical axis is 45°. In such a case the arrangement can be used as a switchable quarter-wave plate, provided the optical retardation, i.e. the product of the effective birefringence of the liquid crystal and the cell gap, is selected to be the quarter of the given wavelength.

The angle of rotation of the optical axis (Φ) is given in good approximation by formula (2)

tan Φ=ēP₀E/(2πK) (2)

wherein
P₀ is the undisturbed pitch of the cholesteric liquid crystal,
ē is the average [ē=½ (e_{splay}+e_{bend})] of the splay flexoelectric coefficient (e_{spay}) and the bend flexoelectric coefficient (e_{bend}),
E is the electric field strength and
K is the average [K=½ (k₁₁+k₃₃)] of the splay elastic constant (k₁₁) and the bend elastic constant (K₃₃).

The ratio ē/K is called the flexoelastic ratio.

This angle of rotation is half the switching angle in a flexoelectric switching element.

The response time (τ) of this electro-optical effect is given in good approximation by formula (3)

τ=[P₀/(2π)]²·γ/K (3)

wherein
γ is the effective viscosity coefficient associated with the distortion of the helix.

There is a critical field (E_{c}) to unwind the helix, which can be obtained from equation (4)

E_{c}=(π²/P₀)·[k₂₂/(ε₀·Δε)]^{1/2} (4)

wherein
k₂₂ is the twist elastic constant,
ε₀ is the permittivity of vacuum and
Δε is the dielectric anisotropy of the liquid crystal.

In this mode, however, several problems are still unresolved, which are, amongst others, difficulties in obtaining the required uniform orientation, an unfavourably high voltage required for addressing which is incompatible with common driving electronics, a not really dark “off state” which deteriorates the contrast and a pronounced hysteresis in the electro-optical characteristics.

As an alternative mode, e.g. to the IPS mode, a relatively new display mode, the so-called uniformly standing helix (USH) mode, may be considered. The USH mode can show improved black levels, even compared to other display modes providing wide viewing angles (e.g. IPS, VA etc.).

For the USH mode, like for the ULH mode, flexoelectric switching has been proposed, using bimesogenic liquid crystal materials. Flexoelectric liquid crystal materials and in particular bimesogenic compounds are known in general from the prior art, see e.g. Hori, K., Iimuro, M., Nakao, A., Toriumi, H., J. Mol. Struc. 2004, 699, 23-29.

However, due to the unfavourably high driving voltage required, the relatively narrow phase range of the chiral nematic materials and their irreversible switching properties, materials from prior art are incompatible with the use in current LCD driving schemes.

For displays of the ULH and USH mode, particular characteristics and parameters can contribute to functionality, especially the birefringence (Δn). The birefringence Δn herein is defined in equation (5)

Δn=nₑ−nₒ (5)

wherein nₑ is the extraordinary refractive index and nₒ is the ordinary refractive index.

The effective or average refractive index n_{av.} is given by the following equation (6).

n_{av.}=[(2nₒ²+nₑ²)/3]^{1/2} (6)

The extraordinary refractive index nₑ and the ordinary refractive index nₒ can be measured using an Abbe refractometer. Δn can then be calculated from equation (5).

Furthermore, for displays utilizing the ULH and USH mode the optical retardation, d*Δn (effective), of the liquid crystal media should preferably be such that equation (7)

sin²(π·d·Δn/λ)=1 (7)

wherein
d is the cell gap and
λ is the wavelength of light
   is satisfied. The allowance of deviation for the right hand side of equation (7) is typically +/−3%.

Moreover, for the ULH/USH mode the dielectric anisotropy (Δε), defined as (ε_{∥}−ε_{⊥}), with ε_{av.} being (ε_{∥}+2ε_{⊥})/3, should typically be as small as possible to prevent unwinding of the helix upon application of the addressing voltage.

Liquid crystal compositions with short cholesteric pitch for flexoelectric devices are known from EP 0 971 016, GB 2 356 629 and Coles, H. J., Musgrave, B., Coles, M. J., and Willmott, J., J. Mater. Chem., 11, p. 2709-2716 (2001). EP 0 971 016 describes mesogenic estradiols, which, as such, have a high flexoelectric coefficient. GB 2 356 629 describes broad generic formulae of bimesogenic compounds and the use of these bimesogenic compounds in flexoelectric devices. The flexoelectric effect therein has been investigated so far in pure cholesteric liquid crystal compounds and in mixtures of homologous compounds only. Most of these compounds were used in binary mixtures consisting of a chiral additive and a nematic liquid crystal material being either a simple, conventional monomesogenic material or a bimesogenic material. These materials have several drawbacks for practical applications, like insufficient temperature ranges of the chiral nematic or cholesteric phase, insufficient flexoelastic ratios and insufficient small angles of rotation.

Non-symmetrically linked bimesogenic compounds are proposed e.g. in WO 2014/005672.

EP 0 233 688 describes bis(phenylethanolamines) and bis(phenoxypropanolamines) useful as beta-agonists.

In Macro Rings. 11. Polynuclear Paracyclophanes' H. Steinberg, Donald J Cram, JACS, (1952), 74, p. 5388-91 related compounds are also described.

Thus, for displays of the ULH and USH mode there is a need in the art for novel liquid crystalline substances and media with advantageous and improved properties.

An object of the present invention is to provide suitable mesogenic compounds which exhibit desirable properties and provide benefits when used in liquid crystal media such that the compounds and the media are useful in and contribute to flexoelectric devices with improved characteristics, in particular in terms of high switching angles and fast response times. In particular, it is an object of the present invention to provide liquid crystal materials which exhibit advantageous properties, e.g. a suitable ratio of ē/K, for use in flexoelectric displays and which therein enable tuning of the working temperature range, while overall a favourably uniform alignment over the entire area of the display cell is obtainable, preferably without the use of a mechanical shearing process, as well as good contrast, high switching angles and fast response times also at low temperatures. In addition, it is an object to provide liquid crystal materials which exhibit low melting points, broad chiral nematic phase ranges, short and temperature-independent pitch lengths and a suitably large flexoelectric effect. Besides suitably wide ranges of the nematic phase, the media should exhibit a rather small rotational viscosity and an at least moderately high specific resistivity. Further objects of the present invention are immediately evident to the person skilled in the art from the following detailed description.

The object is solved by the subject-matter defined in the independent claims, while preferred embodiments are set forth in the respective dependent claims and are further described below.

The present invention in particular provides the following items including main aspects, preferred embodiments and particular features, which respectively alone and in combination contribute to solving the above object and eventually provide additional advantages.

A first aspect of the present invention provides a bimesogenic compound of formula I

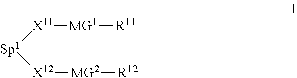

wherein
R¹¹ and R¹² respectively and independently denote a terminal group selected from H, F, Cl, CN, NCS and a straight-chain or branched alkyl group with 1 to 25 C atoms, said alkyl group optionally being substituted by one or more halogen and/or CN groups and optionally having one or more CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another,
MG¹ and MG² respectively and independently denote a mesogenic group comprising one or more cyclic groups selected from aromatic, heteroaromatic, non-aromatic carbocyclic and/or non-aromatic heterocyclic groups, which are connected to each other directly and/or via (a) linking group(s), wherein the respective terminal group R¹¹ or R¹² is directly linked to a cyclic group of the mesogenic group,
Sp¹ denotes alkylene having 1, 3 or 5 to 40 C atoms, wherein optionally one or more CH₂ groups are, respectively and independently, replaced by —O—, —S—, —NH—, —N(CH₃)—, —CO—, —CO—O—, —O—CO—, —O—COO—, —CO—S—, —S—CO—, —CH(halogen)-, —CH(CN)—, —CH═CH— or —C≡C—,
   wherein respectively two O atoms, two —CH═CH— groups and two groups selected from —O—CO—, —S—CO—, —O—COO—, —CO—S— and —CO—O— are not linked directly to one another, and
X¹¹ and X¹² are independently from one another selected from a single bond, —CO—O—, —O—CO—, —O—COO—, —O—, —CH═CH—, —C≡C—, —CF₂—O—, —O—CF₂—, —CF₂—CF₂, —CH₂—O—, —O—CH₂—, —CO—S—, —S—CO—, —CS—S—, —S—CS—, —S—CSS— and —S—,
   wherein in —X¹¹-Sp¹-X¹²— respectively two O atoms, two —CH═CH— groups and two groups selected from —O—CO—, —S—CO—, —O—COO—, —CO—S— and —CO—O— are not linked directly to one another,
      provided that at least one of R¹¹ and R¹² is H,
      or
      provided that at least one of R¹¹ and R¹² is a straight-chain or branched alkyl group with 1 to 25 C atoms, said alkyl group optionally being substituted by one or more halogen and/or CN groups and optionally having one or more CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another, and further at least one of MG¹ and MG² exhibits in addition to the terminal group one or more substituents respectively and independently selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups.

Preferably, the optionally replaced one or more CH₂ groups as defined for R¹¹, R¹² and Sp¹ are non-adjacent CH₂ groups. Furthermore, preferably the respective CH₂ group for R¹, R¹² and Sp¹ directly adjacent to the respective group MG¹, MG², X¹¹ and X¹² is not replaced.

Preferably, the alkyl group provided as the at least one terminal group is a straight-chain or branched alkyl group with 1 to 15 C atoms, more preferably a straight-chain or branched alkyl group with 1 to 9 C atoms, even more preferably a straight-chain or branched alkyl group with 1 to 7 C atoms. The alkyl group may optionally be substituted by one or more halogen and/or CN groups.

According to an embodiment, preferably R¹¹ and R¹² respectively and independently denote a terminal group selected from H, F, Cl, CN, NCS, OCF₃, CF₃, C₂F₅, OC₂F₅ and a straight-chain or branched alkyl group with 1 to 9 C atoms, provided that at least one of R¹¹ and R¹² is H or the alkyl group.

It was surprisingly found that bimesogenic compounds according to present formula I as set forth above can exhibit desirable properties on their own and especially when provided in a liquid crystalline medium. In particular, the provision of hydrogen as at least one terminal group or alternatively the provision of the alkyl group as set forth above as at least one terminal group, while in the case of the alkyl group further providing at least one polar substituent selected from F, Cl, CN, NCS, OCF₃, CF₃, SCH₃, NO₂, NH₂, NHR^{c} and NR^{c}R^{d} on at least one of the mesogenic core groups as defined above, can favourably influence the mesogenic properties. The compounds according to the present invention are especially useful in that the liquid crystal phase range of the liquid crystal material can be set and adjusted, while at the same time favourably maintaining the desired flexoelectric properties. These compounds can thus be particularly advantageous for use in and tuning of mixtures having suitably high e/K, for example by adjusting and optimizing the nematic to twist-bend nematic transition temperature and by favourably influencing the working temperature range of devices using the flexoelectro-optic effect.

Furthermore, the provision of the bimesogenic compounds according to the present invention, in particular in chiral nematic liquid crystal mixtures, can lead to low melting points and broad chiral nematic phases, which exhibit relatively high values of the elastic constant k₁₁, low values of the bend elastic constant k₃₃, and a suitable flexoelectric coefficient.

In the present invention it was advantageously recognized that the properties of bimesogenic compounds and media, including the flexoelectric properties, can be highly dependent on the molecular shape and the dipole direction of the molecule. Among others, the presence or absence as well as the position of polar but also non-polar groups can have an impact on the polarizability and the direction and magnitude of the molecular dipole moment. These properties can in turn have an influence on intermolecular interactions, molecular packing and the physical properties of the medium and can ultimately influence inter alia the flexoelectric properties.

According to the invention at least one of the two terminal groups of the compounds of formula I is either hydrogen or the alkyl group as defined, which are both relatively non-polar. Moreover, in the case of the alkyl group at least one of the two mesogenic groups comprises at least one polar substituent selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups. It is particularly advantageous when this polar substituent as a dipole inducing group is also present in the case of having hydrogen as the at least one terminal group. It was surprisingly found that by including, in addition to the at least one terminal group as set forth, a lateral dipole the flexoelectric response of bimesogenic materials can be favourably influenced.

In another aspect the invention relates to a liquid crystalline medium which comprises one or more bimesogenic compounds according to the invention.

A further aspect of the present invention is a liquid crystal device comprising a liquid crystalline medium which comprises two or more components, wherein one or more of the components is the bimesogenic compound according to the invention.

It is understood that according to the present invention for a given element, in particular for H, C, N, O, F, S, Cl and Br, all possible isotopes are comprised. As such, hydrogen and in particular the hydrogen as the terminal group(s) comprises all isotopes, in particular ¹H and ²H.

The term “liquid crystal”, “mesomorphic compound” or “mesogenic compound”, also shortly referred to as “mesogen”, means a compound which under suitable conditions of temperature, pressure and concentration can exist as a mesophase (nematic, smectic, etc.) or in particular as a LC phase. Non-amphiphilic mesogenic compounds comprise for example one or more calamitic, banana-shaped or discotic mesogenic groups.

The term “bimesogenic compound” as used herein relates to compounds comprising two mesogenic groups in the molecule. Like normal mesogens they can form many mesophases, depending on their structure. In particular, the compounds of formula I may induce a second nematic phase when added to a nematic liquid crystal medium.

The term “mesogenic group” means in this context a group with the ability to induce liquid crystal (LC) phase behaviour. The compounds comprising mesogenic groups, in particular the bimesogenic compounds according to the present invention do not necessarily have to exhibit an LC phase themselves. It is also possible that they show LC phase behaviour only in mixtures with other compounds. For the sake of simplicity, the term “liquid crystal” is used hereinafter for both mesogenic and LC materials.

The term “chiral” in general is used to describe an object that is non-superimposable on its mirror image. “Achiral” (non-chiral) objects are objects that are identical to their mirror image. The terms chiral nematic and cholesteric are used synonymously in this application, unless explicitly stated otherwise.

The wavelength of light referred to in this application is 550 nm, unless explicitly specified otherwise.

The cell gap of the cells preferably is in the range from 1 μm to 20 μm, in particular within the range from 2.0 μm to 10 μm.

For the ULH and USH mode, it is found that the dielectric anisotropy (Δε) should preferably be as small as possible to prevent unwinding of the helix upon application of the addressing voltage. Preferably, Δε should be slightly higher than 0 and more preferably be 0.1 or more, but preferably 10 or less, more preferably 7 or less and even more preferably 5 or less. In the present application the term “dielectrically positive” is used for compounds or components with Δε>3.0, “dielectrically neutral” with −1.5≤Δε≤3.0 and “dielectrically negative” with Δε<−1.5.

Δε is determined at a frequency of 1 kHz and at 20° C. The dielectric anisotropy of the respective compound is determined from the results of a solution of 10% of the respective individual compound in a nematic host mixture. In case the solubility of the respective compound in the host medium is less than 10% its concentration is reduced by a factor of 2 until the resultant medium is stable enough at least to allow the determination of its properties. Preferably the concentration is kept at least at 5%, however, in order to keep the significance of the results as high as possible. The respective capacitance of the test mixtures is determined both in a cell with homeotropic and with homogeneous alignment. For this measurement the cell gap of both types of cells is approximately 20 μm. The voltage applied is a rectangular wave with a frequency of 1 kHz and a root mean square value typically of 0.5 V to 1.0 V, however, it is always selected to be below the capacitive threshold of the respective test mixture.

Δε is defined as (ε_{∥}−ε_{⊥}), and ε_{av.} is (ε_{∥}+2ε_{⊥})/3. The dielectric permittivity of the compounds is determined from the change of the respective values of a host medium upon addition of the compounds of interest. The values are extrapolated to a concentration of the compounds of interest of 100%. The typical host mixture is disclosed in H. J. Coles et al., J. Appl. Phys. 2006, 99, 034104 and has the composition given in Table 1.

TABLE 1
Host mixture composition

| Compound | Concentration |
|---|---|
| F-PGI-ZI-9-Z-GP-F | 25% |
| F-PGI-ZI-11-Z-GP-F | 25% |
| F-PGI-O-5-O-PP-N | 9.5% |
| F-PGI-O-7-O-PP-N | 39% |
| CD-1 | 1.5% |

Without limiting the present invention thereby, in the following the invention is illustrated by the detailed description of the aspects, embodiments and particular features, and particular embodiments are described in more detail.

In a first aspect the invention relates to the bimesogenic compound of formula I as set forth above. It was surprisingly found that compounds according to formula I can be particularly advantageous for use in and tuning of mixtures having suitably high flexoelastic ratios, especially for setting or adjusting the working temperature range without negatively impacting the overall flexoelastic ratio and component solubilities.

Preferably, in the bimesogenic compounds according to the invention the mesogenic groups MG¹ and MG² respectively and independently comprise at least one 6-atomic ring and optionally one, two or more 5-atomic rings, wherein in case of comprising two or more rings at least two of these rings are optionally linked by a 2-atomic linking group, preferably selected from the group of —CO—O—, —O—CO—, —CH₂—O—, —O—CH₂—, —CF₂—O—, —O—CF₂—, —CH₂CH₂—, —CF₂CF₂—, —CH═CH—, —CF═CF—, and —C≡C—, more preferably —CO—O—, —O—CO—, —CH₂—O—, —O—CH₂—, —CF₂—O— and —O—CF₂—, and wherein in MG¹ and MG² the respective cyclic groups directly connected to the respective terminal groups are respectively and independently 1,4-phenylene, wherein optionally one or two non-adjacent CH groups each may be replaced by an N atom, and which optionally is substituted by one or more polar substituents selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups, and/or by one or more alkyl groups each independently having 1 to 9 C atoms and/or by one or more alkoxy groups each independently having 1 to 9 C atoms,

or 1,4-cyclohexylene, wherein optionally one or two non-adjacent CH₂ groups are replaced by O and/or S, and which optionally is substituted by one or more polar substituents selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups and/or by one or more alkyl groups each independently having 1 to 9 C atoms and/or by one or more alkoxy groups each independently having 1 to 9 C atoms.

In an embodiment at least one of MG¹ and MG² exhibits, in addition to the terminal group, at least one polar substituent selected from F, Cl, CN, NCS, OCF₃ and CF₃ in a lateral position of a cyclic group.

It is particularly preferred that in MG¹ and MG² the respective cyclic groups directly connected to the respective terminal groups are respectively and independently the 1,4-phenylene as set forth above. In this preferred embodiment the terminal groups R¹¹ and R¹² are thus attached to the terminal cyclic ring of the respective mesogenic group in the para-position.

Preferred compounds of formula I are compounds in which
—X¹¹-Sp¹-X¹²— is -Sp¹-, -Sp¹-O—, —O-Sp¹-, —O-Sp¹-O—, -Sp¹-CO—O—, —O—CO-Sp¹-, —O-Sp¹-CO—O—, —O—CO-Sp¹-O—, or —O—CO-Sp¹-CO—O—, preferably -Sp¹-, -Sp¹-O—, —O-Sp¹-, —O-Sp¹-O—, -Sp¹-CO—O—, —O—CO-Sp¹- or —O—CO-Sp¹-CO—O—, more preferably -Sp¹-, —O-Sp¹-O—, -Sp¹-CO—O— or —O—CO-Sp¹-CO—O—.

Sp¹ preferably is a linear or branched alkylene group having 1, 3 or 5 to 40 C atoms, more preferably 1, 3 or 5 to 25 C atoms, even more preferably 1, 3 or 5 to 15 C atoms, and most preferably 5 to 15 C atoms, in which optionally, one or more non-adjacent CH₂ groups may be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—.

Typical spacer groups are for example —(CH₂)ₒ—, —(CH₂CH₂O)ₚ—CH₂CH₂—, with o being an integer from 5 to 40, preferably from 5 to 25, more preferably from 5 to 15, and p being an integer from 1 to 8, in particular 1, 2, 3 or 4.

Preferred spacer groups are, for example, pentylene, hexylene, heptylene, octylene, nonylene, decylene, undecylene, dodecylene, octadecylene, diethyleneoxyethylene, dimethyleneoxybutylene, pentenylene, heptenylene, nonenylene and undecenylene.

Especially preferred are inventive compounds of formula I, wherein Sp¹ is denoting alkylene with 5 to 15 C atoms. Straight-chain alkylene groups are particularly preferred.

Preferred are spacer groups, which are straight-chain alkylene with odd numbers of C atoms, preferably having 5, 7, 9, 11, 13 or 15 C atoms, more preferred are straight-chain alkylene spacers having 7, 9 and 11 C atoms.

In another embodiment of the present invention the spacer groups are straight-chain alkylenes with even numbers of C atoms, preferably having 6, 8, 10, 12 and 14 C atoms. This embodiment is particularly preferred in case one of X¹¹ and X¹² consists of one atom, i.e. is —S— or —O—, or of three atom links, e.g. is —S—CO—, —S—CO—S— or —S—CS—S—, and the other does not consist of one or three C atoms.

In an embodiment inventive compounds of formula I comprise Sp¹ denoting partially or completely deuterated alkylene with 5 to 15 C atoms, wherein deuterated straight-chain alkylene groups are preferred. Most preferred are partially deuterated straight-chain alkylene groups.

According to a particularly preferred embodiment Sp¹ is —(CH₂)ₖ— with k being 1, 3 or an integer from 5 to 15, more preferably an odd, i.e. uneven integer, and most preferably 7 or 9, wherein one or more H atoms in —(CH₂)ₖ— may optionally and independently of each other be replaced by F or CH₃.

Further preferred compounds of formula I are compounds in which

R¹¹-MG¹- is a group of (partial) formula III

R¹¹-A¹¹-(Z¹¹-A¹²)ⱼ- III

wherein
R¹¹ is as set forth above,
Z¹¹ is, independently of each other in each occurrence, a single bond, —COO—, —OCO—, —O—CO—O—, —OCH₂—, —CH₂O—, —OCF₂—, —CF₂O—, —CH₂CH₂—, —(CH₂)₄—, —CF₂CF₂—, —CH═CH—, —CF═CF—, —CH═CH—COO—, —OCO—CH═CH— or —C≡C—, optionally substituted with one or more of F, S and/or Si, preferably a single bond,
A¹¹ is 1,4-phenylene, wherein optionally one or two non-adjacent CH groups each may be replaced by an N atom, and which optionally is substituted by one or more substituents selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups, and/or by one or more alkyl groups each independently having 1 to 9 C atoms and/or by one or more alkoxy groups each independently having 1 to 9 C atoms, or
   trans-1,4-cyclohexylene in which, in addition, one or two non-adjacent CH₂ groups may be replaced by O and/or S,
A¹² is, independently of each other in each occurrence, a 5-atomic ring, preferably selected from thiophene-2,5-diyl, furane-2,5-diyl, thiazole-diyl, thiadiazole-diyl, it being possible for all these groups to be unsubstituted, mono-, di-, tri- or tetrasubstituted with F, Cl, CN or alkyl, alkoxy, alkylcarbonyl or alkoxycarbonyl groups with 1 to 7 C atoms, wherein one or more H atoms may be substituted by F or Cl, preferably F, Cl, CH₃ or CF₃,
   or a 6-atomic ring, preferably selected from 1,4-phenylene, wherein in addition one or more CH groups may be replaced by N, trans-1,4-cyclohexylene in which, in addition, one or two non-adjacent CH₂ groups may be replaced by O and/or S, 1,4-cyclohexenylene, 1,4-bicyclo-(2,2,2)-octylene, piperidine-1,4-diyl, naphthalene-2,6-diyl, decahydro-naphthalene-2,6-diyl, 1,2,3,4-tetrahydro-naphthalene-2,6-diyl, cyclobutane-1,3-diyl, spiro[3.3]heptane-2,6-diyl or dispiro[3.1.3.1] decane-2,8-diyl, it being possible for all these groups to be unsubstituted, mono-, di-, tri- or tetrasubstituted with F, Cl, CN, NCS, alkyl, alkoxy, alkylcarbonyl or alkoxycarbonyl groups with 1 to 7 C atoms, wherein one or more H atoms may be substituted by F or Cl, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups, and
j is 0, 1, 2, 3 or 4, preferably 1, 2 or 3, and most preferably 1 or 2.

Optionally R¹¹ and MG¹ can be replaced respectively by R¹² and MG² having the meanings as set forth above. It is particularly preferable when R¹-MG¹- and R¹²-MG²- are, each independently from one another, a group of (partial) formula III.

Sub-groups comprised in preferred mesogenic groups comprising only 6-membered rings are listed below. For reasons of simplicity, Phe in these groups is 1,4-phenylene, PheL is a 1,4-phenylene group which is substituted by 1 to 4 groups L, with L respectively and independently being F, Cl, CN, NCS, OCF₃, CF₃, SCH₃, NO₂, NH₂, NHR^{c} and NR^{c}R^{d}, wherein R^{c} and R^{d} each independently are a straight-chain or branched alkyl group with 1 to 6 C atoms, said alkyl group optionally being substituted by one or more halogen and/or CN groups, preferably being F or CN, more preferably being CN, and Cyc is 1,4-cyclohexylene, preferably trans-1,4-cyclohexylene, as well as their mirror images.

-Phe-Z-Phe- IV-1

-Phe-Z-Cyc- IV-2

-Cyc-Z-Cyc- IV-3

-Phe-Z-PheL- IV-4

-PheL-Z-Phe- IV-5

-PheL-Z-Cyc- IV-6

-PheL-Z-PheL- IV-7

-Phe-Z-Phe-Z-Phe- IV-8

-Phe-Z-Phe-Z-Cyc- IV-9

-Phe-Z-Cyc-Z-Phe- IV-10

-Cyc-Z-Phe-Z-Cyc- IV-11

-Phe-Z-Cyc-Z-Cyc- IV-12

-Cyc-Z-Cyc-Z-Cyc- IV-13

-Phe-Z-Phe-Z-PheL- IV-14

-Phe-Z-PheL-Z-Phe- IV-15

-PheL-Z-Phe-Z-Phe- IV-16

-PheL-Z-Phe-Z-PheL- IV-17

-PheL-Z-PheL-Z-Phe- IV-18

-PheL-Z-PheL-Z-PheL- IV-19

-Phe-Z-PheL-Z-Cyc- IV-20

-Phe-Z-Cyc-Z-PheL- IV-21

-Cyc-Z-Phe-Z-PheL- IV-22

-PheL-Z-Cyc-Z-PheL- IV-23

-PheL-Z-PheL-Z-Cyc- IV-24

-PheL-Z-Cyc-Z-Cyc- IV-25

-Cyc-Z-PheL-Z-Cyc- IV-26

wherein Z has one of the meanings of Z¹¹ as set forth above, preferably is, independently of each other in each occurrence, single bond —COO—, —OCO—, —O—CO—O—, —OCH₂—, —CH₂O—, —OCF₂— or —CF₂O—.

In a preferred embodiment at least one of MG¹ and MG² of the bimesogenic compounds of formula I comprises a cyclic group selected from the structures represented by

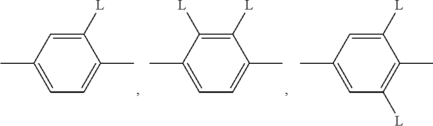

and the mirror images thereof,
wherein L, in each occurrence independently from one another, denotes F, Cl, CN, NCS, OCF₃, CF₃, SCH₃, NO₂, NH₂, NHR^{c} and NR^{c}R^{d}, wherein R^{c} and R^{d} each independently is a straight-chain or branched alkyl group with 1 to 6 C atoms, said alkyl group optionally being substituted by one or more halogen and/or CN groups, preferably denotes F or CN, more preferably denotes CN.

In an embodiment, both MG¹ and MG² comprise one of the above structures.

The bimesogenic compound according to the present invention more preferably comprises one of the structures represented by

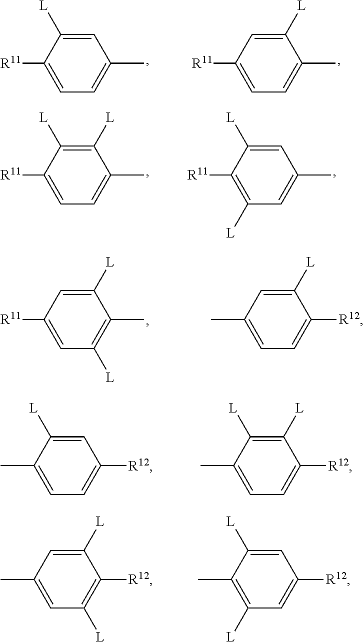

even more preferably comprises one of the structures represented by

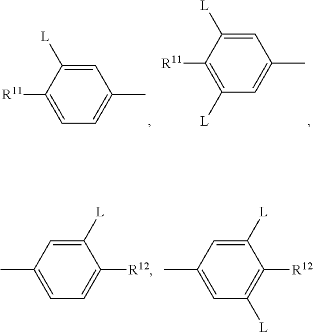

wherein R¹¹, R¹² and L have the meanings as set forth above, and wherein preferably R¹¹ and R¹² denote H. In another preferred embodiment, R¹¹ and R¹² in the above structures are the alkyl group as defined above.

In an embodiment both terminal ends of the bimesogenic compound according to the invention exhibit, respectively and independently, one of the structures shown above.

In a preferred embodiment in the bimesogenic compounds according to the invention at least one of MG¹ and MG² comprises a cyclic group selected from the structures represented by

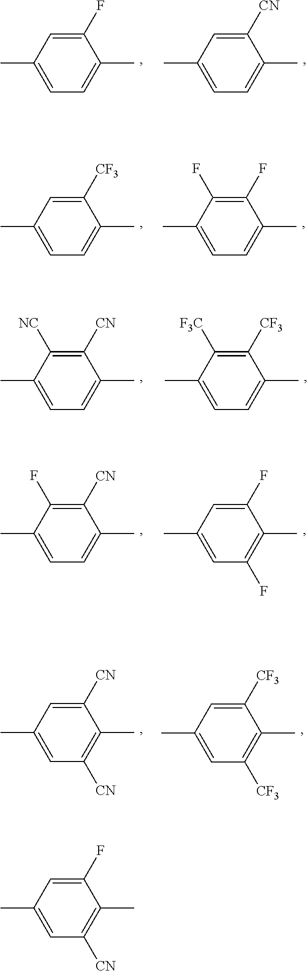

and the mirror images thereof.

Preferably, said cyclic group is directly connected to the respective terminal group R¹¹ or R¹².

In a particularly preferred embodiment the bimesogenic compounds according to the invention thus comprise one of the structures represented by

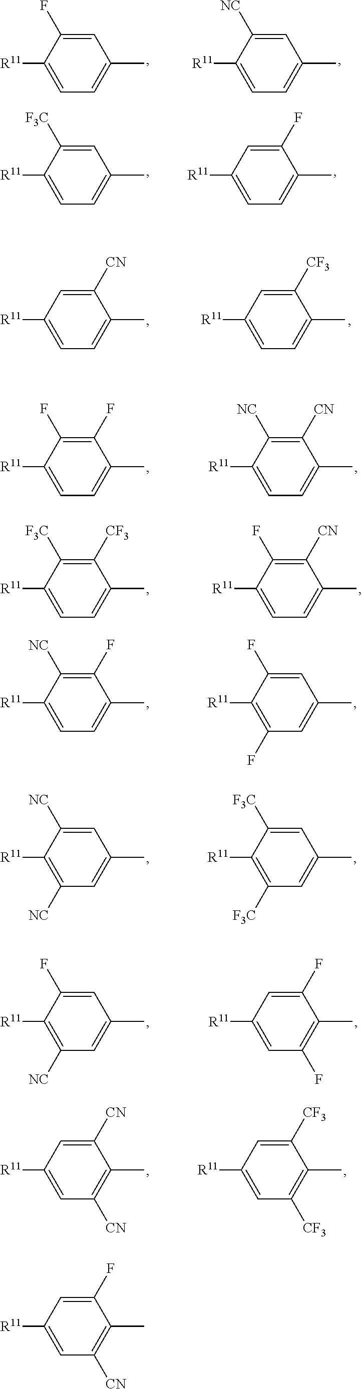

wherein optionally R¹¹ can be replaced by R¹².

It is particularly preferred that the bimesogenic compounds according to the invention comprise one of the structures represented by

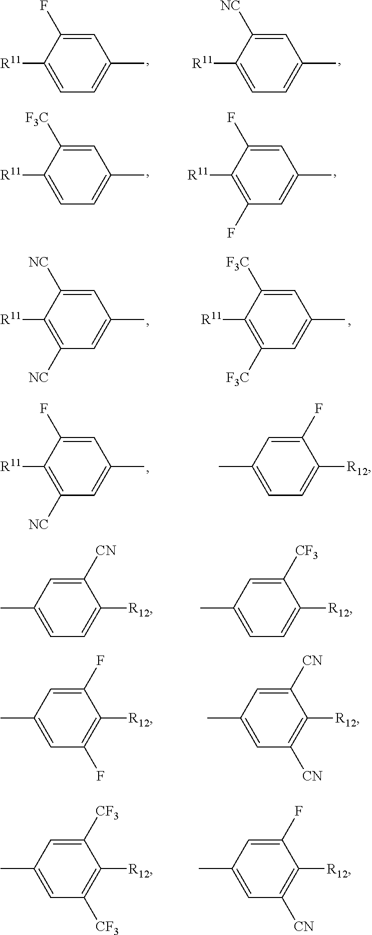

more preferably comprising one of the structures represented by

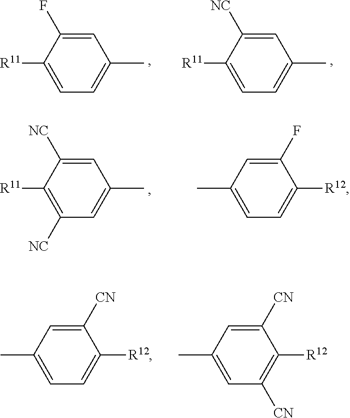

wherein R¹¹ and R¹² respectively and independently denote H or the alkyl group as defined above and L has the meaning as defined above. It is particularly preferred that both R¹¹ and R¹² are H.

In an embodiment both terminal ends respectively comprising the terminal groups R¹¹ or R¹² attached to the respective terminal cyclic group of the respective mesogenic group are selected from one of the above preferred structures.

In a particularly preferred embodiment the bimesogenic compounds according to the invention comprise one of the structures represented by

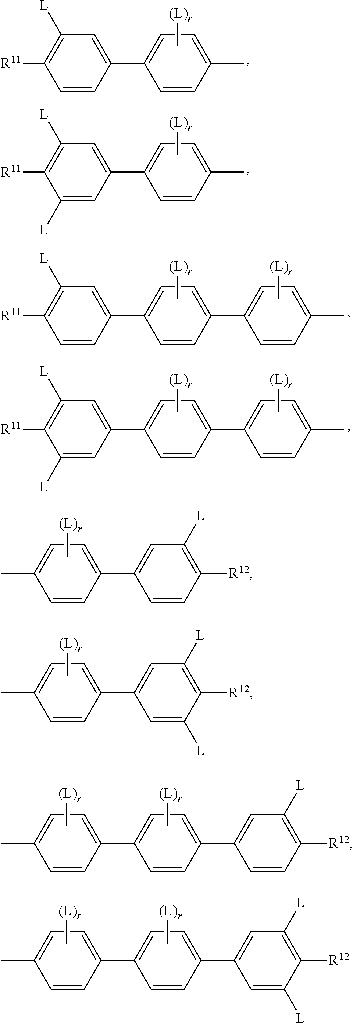

wherein R¹¹ and R¹² respectively and independently denote H or the alkyl group as defined above, L has the meaning as defined above, and r respectively and independently is 0, 1, 2, 3 or 4, preferably r is 0, 1 or 2, more preferably r is 0 or 1.

It is even more preferred that the bimesogenic compounds according to the invention comprise one of the structures represented by

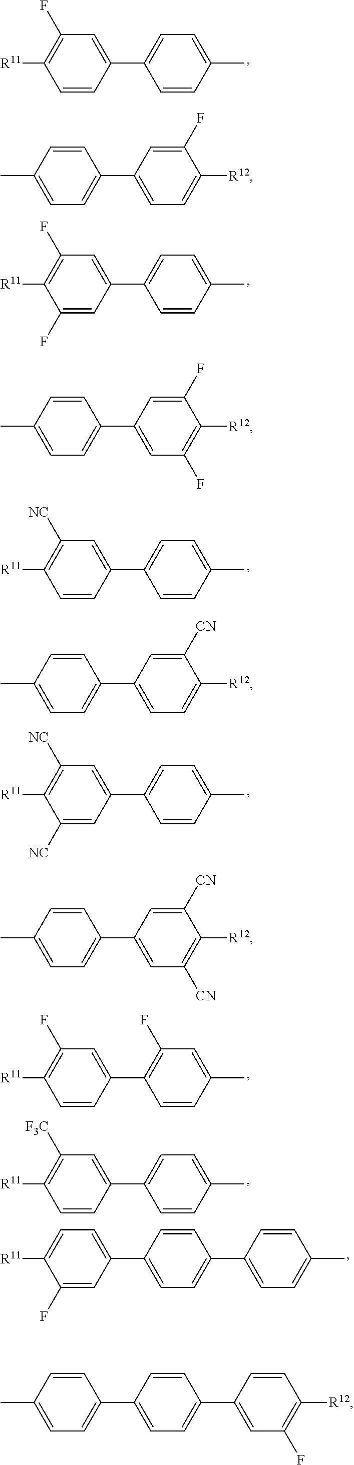

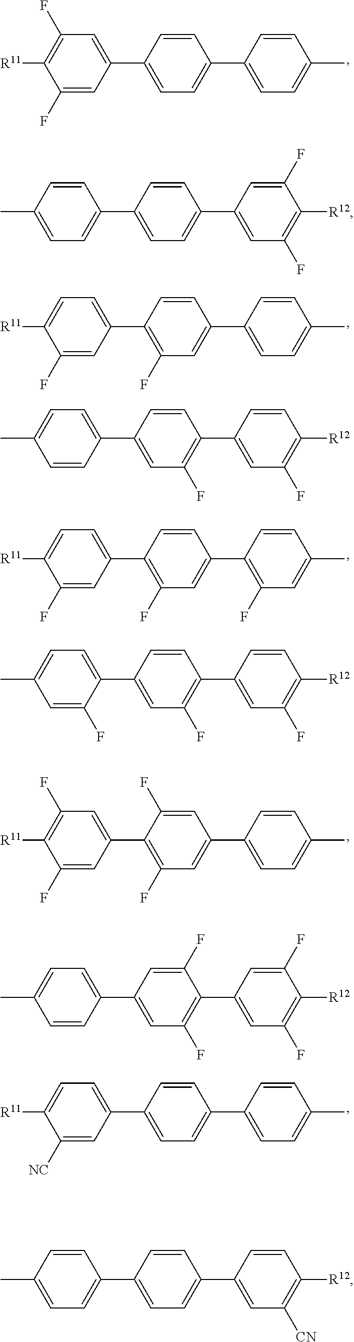

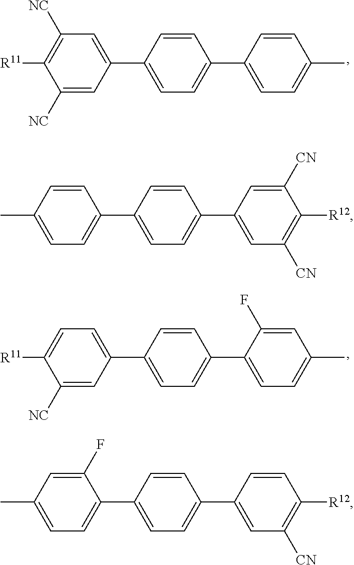

wherein R¹¹ and R¹² respectively and independently denote H or the alkyl group as defined above, preferably denote H.

In an embodiment both terminal ends respectively comprising the terminal groups R¹¹ or R¹² attached to the respective mesogenic group are selected from one of the above particularly preferred structures.

According to one embodiment in the compounds of formula I at least one of R¹¹ and R¹² is hydrogen. In a specific embodiment both terminal groups are hydrogen. In this case it is even more preferable when both terminal ends of the bimesogenic compounds according to formula I comprise respectively hydrogen as the terminal groups each attached in the para-position to the 1,4-phenylene group as defined above, which is preferably substituted as shown above, of the respective mesogenic groups, wherein preferably at least one mesogenic group exhibits one or more of the polar groups as set forth above in (a) lateral position(s), in particular in (a) lateral position(s) of the respective terminal 1,4-phenylene group.

In this case with both terminal groups being hydrogen the molecular properties of the bimesogenic compounds can particularly favourably be tuned or set such that their use in a liquid crystalline medium can influence e.g. the phase behaviour as desired, while substantially maintaining or respectively obtaining the desired flexoelectric effects and in particular a suitable flexoelastic constant.

According to another embodiment in the compounds of formula I at least one of R¹¹ and R¹² is the alkyl group as set forth above. In this case it can be preferable that both terminal groups of the bimesogenic compounds according to formula I are, in each occurrence independently from one another, the alkyl group as defined above. Similar to the case where both terminal groups are hydrogen, by providing two alkyl groups as defined above as the terminal groups in the bimesogenic compounds the above mentioned particularly favourable effects can also be obtainable.

In a further embodiment either of R¹¹ and R¹² is hydrogen, while the other terminal group is the alkyl group, which can likewise result in a favourable adjustment of the properties of the compounds and media.

In an embodiment in the compounds of formula I the respective substructures R¹-MG¹-X¹¹— and R¹²-MG²-X¹²— are different from each other. In another embodiment said substructures R¹-MG¹-X¹¹— and R¹²-MG²-X¹²— in formula I are identical to each other.

Particularly preferred compounds of formula I are selected from the group of compounds of formulae IA to IO,

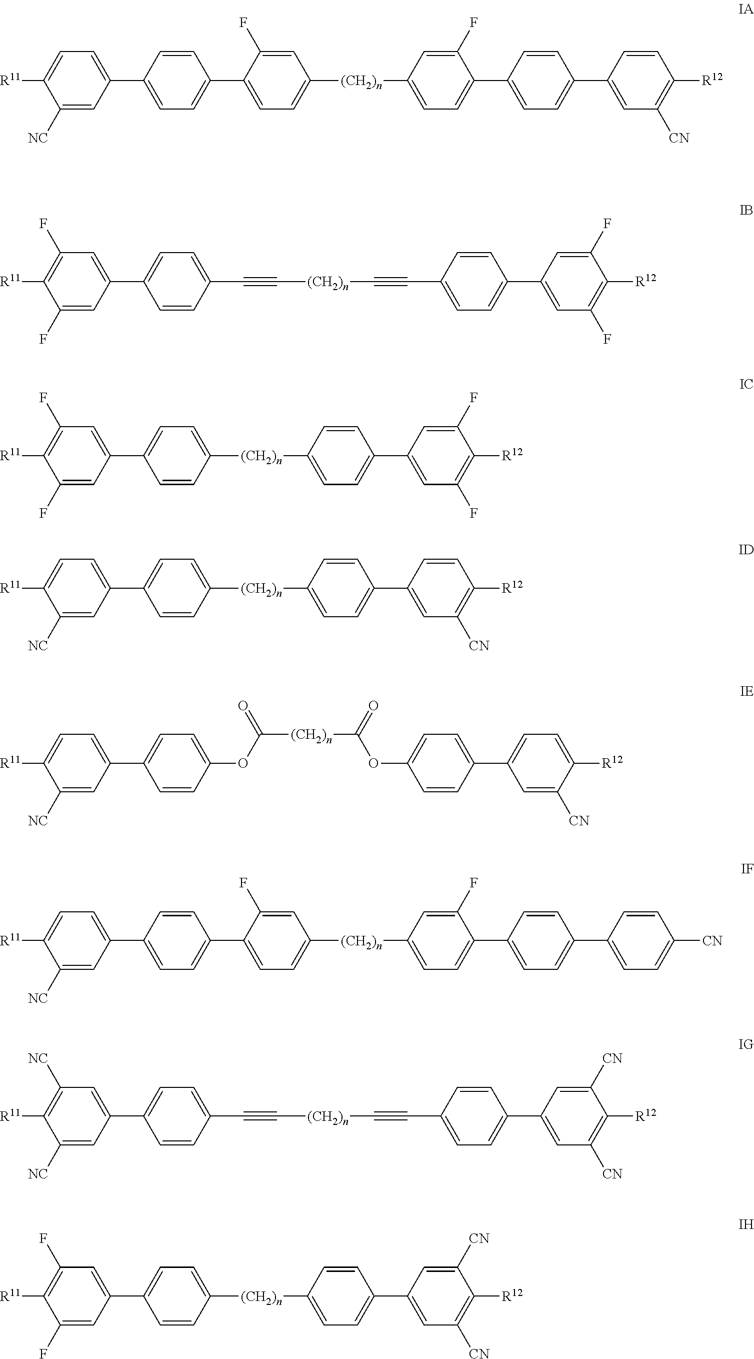

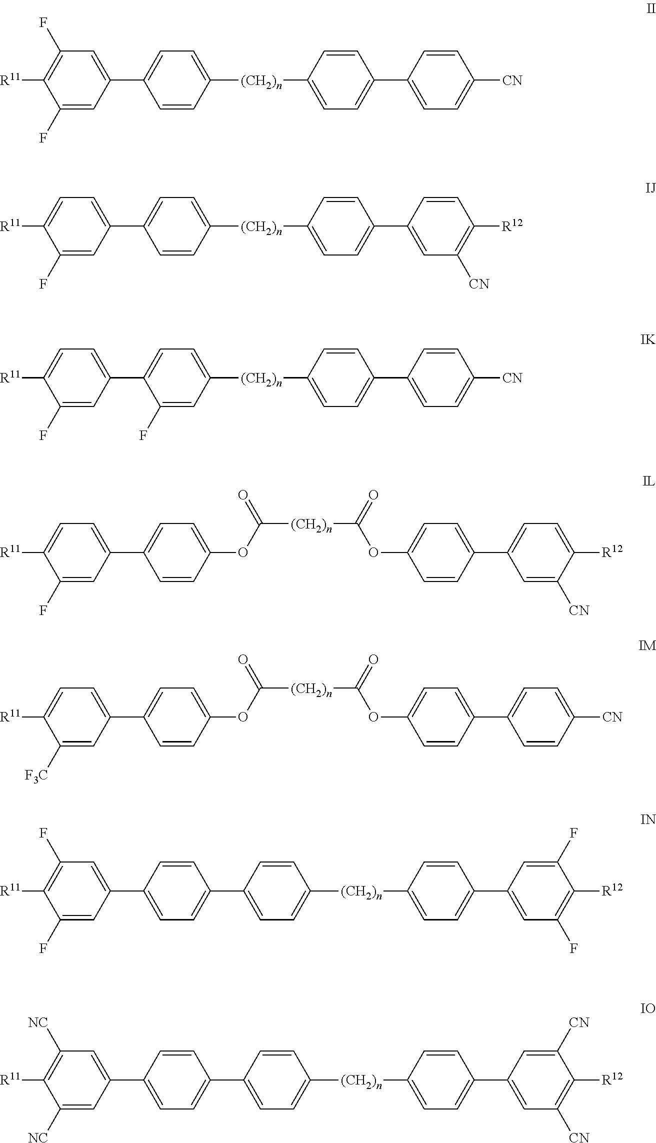

wherein the alkylene spacers —(CH₂)ₙ— shown are exemplary only and n therein is an integer of 3 or from 5 to 15, preferably 5, 7 or 9, and wherein R¹¹ and R¹² independently from each other have the meanings as defined above.

In an embodiment R¹¹ is H, preferably R¹¹ and R¹² are H.

In another embodiment R¹¹ is alkyl as set forth above, preferably R¹¹ and R¹² are respectively and independently alkyl as set forth above. For compound IL it is particularly preferred that R¹¹ and R¹² are both n-propyl.

The compounds of formula I can be synthesized according to or in analogy to methods which are known per se and which are described in standard works of organic chemistry such as, for example, Houben-Weyl, Methoden der organischen Chemie, Thieme-Verlag, Stuttgart. A preferred method of preparation can be taken from the following synthesis schemes.

Synthesis Scheme 1: Preparation of

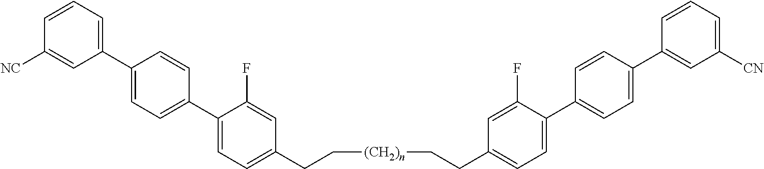

The compounds of interest can be prepared according to the following scheme.

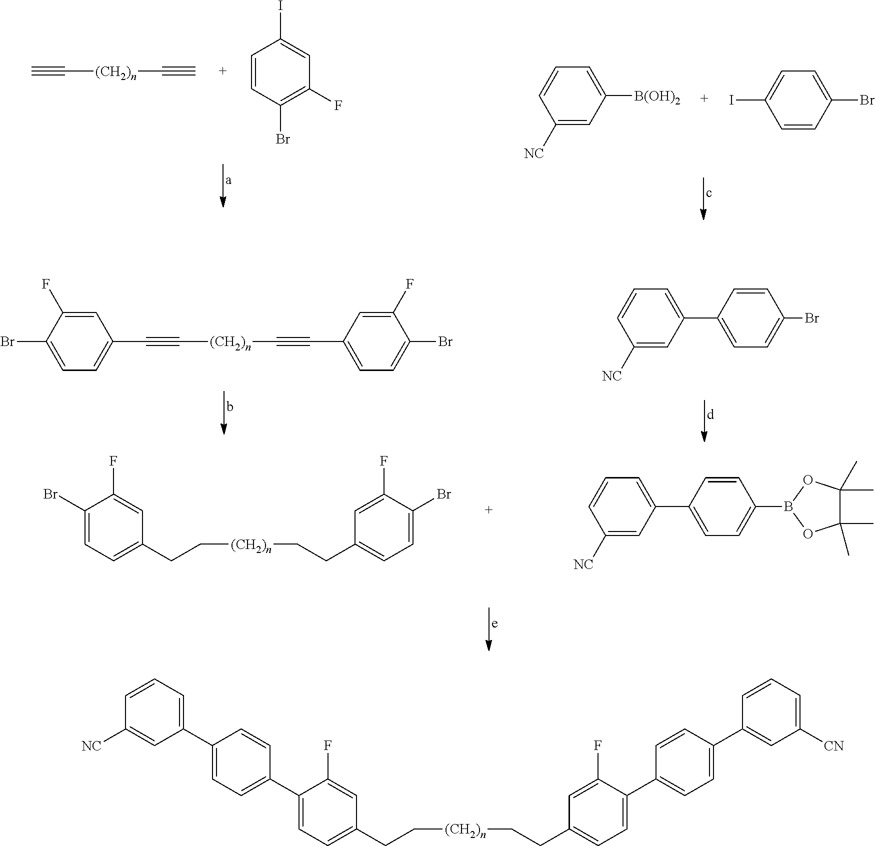

wherein the alkylene spacers —(CH₂)ₙ— shown are exemplary only, wherein n is an integer selected from 3 and 5 to 15, preferably from 5, 7 and 9.

In the conversion steps are preferably used

a) Pd(PPh₃)₂Cl₂, Cu(I)I, DIPA, THF

b) H₂, Pd/C, THF

c) Pd(PPh₃)₂Cl₂, K₂CO₃, H₂O, THF

d) Bis(pinacolato)diboron, Pd[P(cy)₃]₂Cl₂, KOAc, H₂O, THF

e) Pd(PPh₃)₂Cl₂, NaBO₂, H₂O, THF.

Synthesis Scheme 2: Preparation of

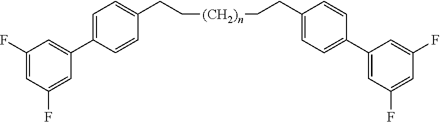

The compounds of interest can be prepared according to the following scheme.

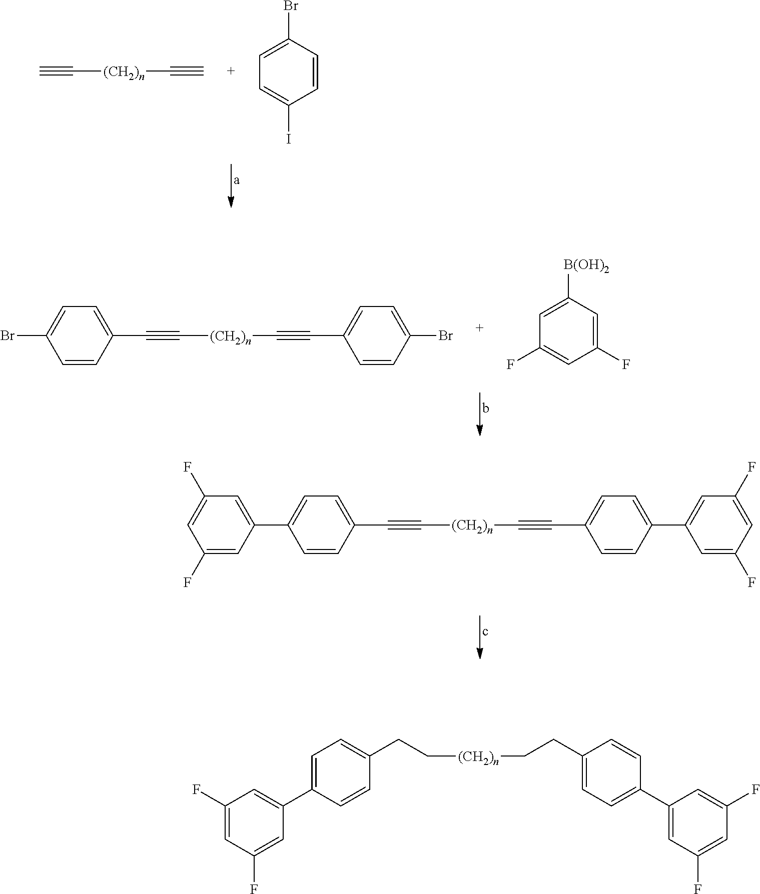

wherein the alkylene spacers —(CH₂)ₙ— shown are exemplary only, wherein n is an integer selected from 3 and 5 to 15, preferably from 5, 7 and 9.

In the conversion steps are preferably used

a) Pd(PPh₃)₂Cl₂, Cu(I)I, DIPA, THF

b) Pd(PPh₃)₂Cl₂, Na₂CO₃, H₂O, THF

c) H₂, Pd/C, THF.

Synthesis Scheme 3: Preparation of

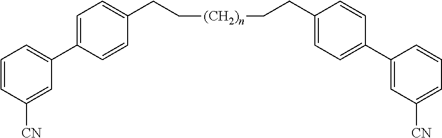

The compounds of interest can be prepared according to the following scheme.

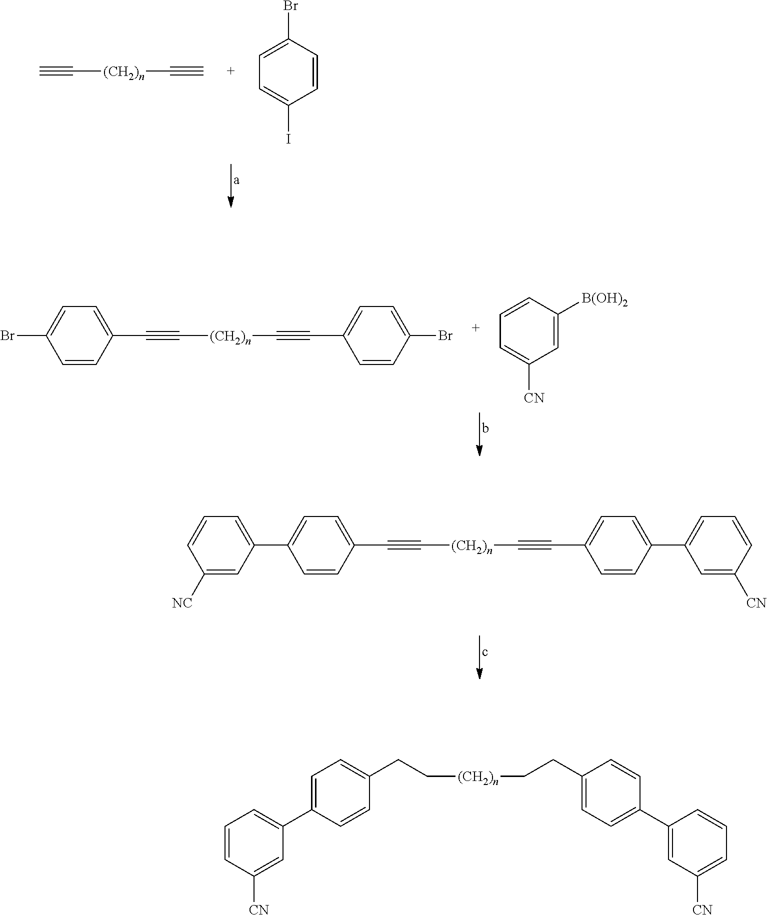

wherein the alkylene spacers —(CH₂)ₙ— shown are exemplary only, wherein n is an integer selected from 3 and 5 to 15, preferably from 5, 7 and 9.

In the conversion steps are preferably used

a) Pd(PPh₃)₂Cl₂, Cu(I)I, DIPA, THF

b) Pd(dppf)Cl₂, Na₂CO₃, H₂O, Dioxane

c) H₂, Pd/C, THF.

Synthesis Scheme 4: Preparation of

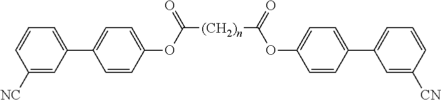

The compounds of interest can be prepared according to the following scheme.

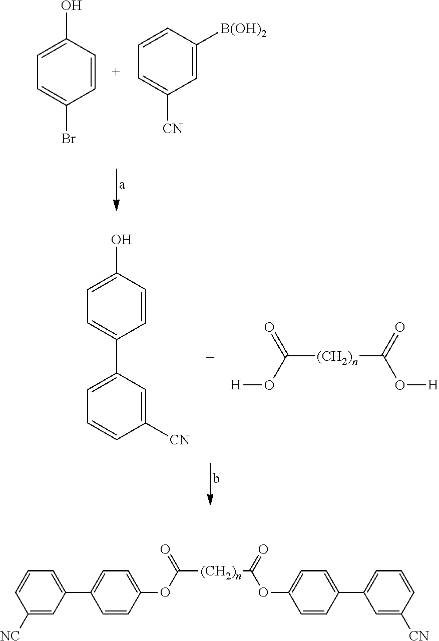

wherein the alkylene spacers —(CH₂)ₙ— shown are exemplary only, wherein n is an integer selected from 3 and 5 to 15, preferably from 5, 7 and 9.

In the conversion steps are preferably used

a) Pd(dppf)Cl₂, Na₂CO₃, H₂O, Dioxane

b) DCC, DMAP, DCM.

The compounds of formula I are preferably accessible according to the exemplified reaction scheme(s).

In an embodiment according to the invention preferably bimesogenic compounds of formula I are provided, wherein the compounds UIP-n-PU, 5-UIP-7-PU-5, m-UIP-O-n-O-PU-k, m-CP-n-Z-GP-N, m-CP-n-Z-PGP-N, m-CP-n-Z—PUU—N and m-CPGI-O-n-O-GPP-k are excluded from the bimesogenic compounds of formula I. The compound designations used are explained in Tables A-C and exemplified in Table D below.

According to another embodiment, MG¹ and MG² preferably comprise only aromatic rings as the cyclic groups, wherein, in addition to the first and second terminal groups, no more than one F is overall provided as a substituent on the mesogenic groups.

In another embodiment, preferably the at least one substituent provided in addition to respectively R¹¹ or R¹² on at least one of MG¹ and MG² is selected from Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups, more preferably is selected from Cl, CN, NCS, OCF₃, CF₃ and SCH₃, even more preferably is CN.

The bimesogenic compounds according to the invention are useful in liquid crystalline media, wherein one or more of said compounds may be used in a respective medium.

When added to a nematic liquid crystalline mixture compounds of formula I may produce a phase below the nematic. An indication of the influence of bimesogenic compounds on nematic liquid crystal mixtures was reported by Barnes, P. J., Douglas, A. G., Heeks, S. K., Luckhurst, G. R., Liquid Crystals, 1993, Vol. 13, No. 4, 603-613. In particular, this reference exemplifies highly polar alkyl spacered dimers and perceives a phase below the nematic, presumably a type of smectic.

A photograph of an existing mesophase below the nematic phase was published by Henderson, P. A., Niemeyer, O., Imrie, C. T. in Liquid Crystals, 2001, Vol. 28, No. 3, 463-472, but which was not further investigated.

In Liquid Crystals, 2005, Vol. 32, No. 11-12, 1499-1513 Henderson, P. A., Seddon, J. M. and Imrie, C. T. reported that the phase below the nematic belonged in some special examples to a smectic C phase. An additional nematic phase below the first nematic was reported by Panov, V. P., Ngaraj, M., Vij, J. K., Panarin, Y. P., Kohlmeier, A., Tamba, M. G., Lewis, R. A. and Mehl, G. H. in Phys. Rev. Lett. 2010, 105, 1678011-1678014.

It is noted that liquid crystal mixtures comprising the inventive bimesogenic compounds of formula I may also show a mesophase that is being assigned as a second nematic phase. This mesophase exists at a lower temperature than the original nematic liquid crystalline phase and may be observed in the present mixture concepts.

Accordingly, the bimesogenic compounds of formula I according to the present invention may allow the second nematic phase to be induced in nematic mixtures that do not have this phase normally. Furthermore, varying the amounts of the compounds of formula I can allow the phase behaviour of the second nematic to be tailored to the required temperature.

In another aspect the invention thus relates to a liquid crystalline medium which comprises one or more bimesogenic compounds according to the invention.

Preferred embodiments of liquid crystal compositions and mixtures according to the invention are indicated below.

The media according to the invention preferably comprise one, two, three, four or more, preferably one, two or three, compounds of the formula I.

The amount of compounds of formula I in the liquid crystalline medium is preferably from 1 to 50%, more preferably from 5 to 40% and even more preferably from 10 to 30% by weight of the total mixture.

In a preferred embodiment the liquid crystalline medium according to the present invention comprises additionally one or more compounds of formula II, like those or similar to those known from GB 2 356 629,

R²¹-MG²¹-X²¹-Sp²-X²²-MG²²-R²² II

wherein
R²¹ and R²² are each independently H, F, Cl, CN, NCS or a straight-chain or branched alkyl group with 1 to 25 C atoms, said alkyl group optionally being substituted by one or more halogen and/or CN groups and optionally having one or more non-adjacent CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C—,
MG²¹ and MG²² are each independently a mesogenic group,
Sp² is a spacer group comprising 5 to 40 C atoms, wherein one or more non-adjacent CH₂ groups may also be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—, and
X²¹ and X²² are each independently —O—, —S—, —CO—, —COO—, —OCO—, —O—CO—O—, —CO—NH—, —NH—CO—, —CH₂CH₂—, —OCH₂—, —CH₂O—, —SCH₂—, —CH₂S—, —CH═CH—, —CH═CH—COO—, —OCO—CH═CH—, —C≡C— or a single bond,
   provided that the compounds of formula I are excluded from the compounds of formula II.

The mesogenic groups MG²¹ and MG²² are preferably selected from the structures as define above in (partial) formula III.

In an embodiment compounds of formula II are preferred wherein R²¹-MG²¹-X²¹— and R²²-MG²²-X²²— are identical.

Another embodiment of the present invention relates to compounds of formula II wherein R²¹-MG²¹-X²¹— and R²²-MG²²-X²²— are different.

Especially preferred are compounds of formula II wherein the mesogenic groups MG²¹ and MG²² comprise one, two or three six-membered rings.

Particularly preferable are the mesogenic groups selected from the subformulae IV-1, IV-4, IV-6, IV-7, IV-13, IV-14, IV-15, IV-16, IV-17 and IV-18. In these preferred groups Z in each case independently has one of the meanings of Z¹¹ as given in formula III. Preferably Z is —COO—, —OCO—, —CH₂CH₂—, —C≡C— or a single bond.

Preferably, compounds of formula II have polar terminal groups. In particular, R²¹ and R²² are preferably selected from CN, NO₂, halogen, OCH₃, OCN, SCN, COR^{x} or COOR^{x}, wherein R^{x} is optionally fluorinated alkyl with 1 to 4 C atoms, preferably 1 to 3 C atoms. Halogen preferably is F or Cl, more preferably is F.

Especially preferably R²¹ and R²² in formula II are selected from F, Cl, CN, NO₂, OCH₃, COCH₃, COC₂H₅, COOCH₃, COOC₂H₅, CF₃, C₂F₅, OCF₃, OCHF₂ and OC₂F₅, in particular from F, Cl, CN, OCH₃ and OCF₃.

As for the spacer group Sp² in formula II, all groups can be used that are known for this purpose in the art. The spacer group Sp² preferably is a linear or branched alkylene group having 5 to 40 C atoms, more preferably 5 to 25 C atoms, even more preferably 5 to 15 C atoms, in which, in addition, one or more non-adjacent CH₂ groups may be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—.

Typical spacer groups are for example —(CH₂)ₒ—, —(CH₂CH₂O)ₚ—CH₂CH₂—, —CH₂CH₂—S—CH₂CH₂— or —CH₂CH₂—NH—CH₂CH₂—, with o being an integer from 5 to 40, preferably from 5 to 25, even more preferably from 5 to 15, and p being an integer from 1 to 8, in particular 1, 2, 3 or 4.

Preferred spacer groups are, for example, pentylene, hexylene, heptylene, octylene, nonylene, decylene, undecylene, dodecylene, octadecylene, diethyleneoxyethylene, dimethyleneoxybutylene, pentenylene, heptenylene, nonenylene and undecenylene.

Especially preferred are compounds of formula II, wherein Sp² is denoting alkylene with 5 to 15 C atoms. Straight-chain alkylene groups are especially preferred.

In another preferred embodiment of the invention chiral compounds of formula II comprise at least one spacer group that is a chiral group.

X²¹ and X²² in formula II denote preferably —O—, —CO—, —COO—, —OCO—, —O—CO—O— or a single bond.

Particularly preferred are the following compounds selected from formulae II-1 to II-4:

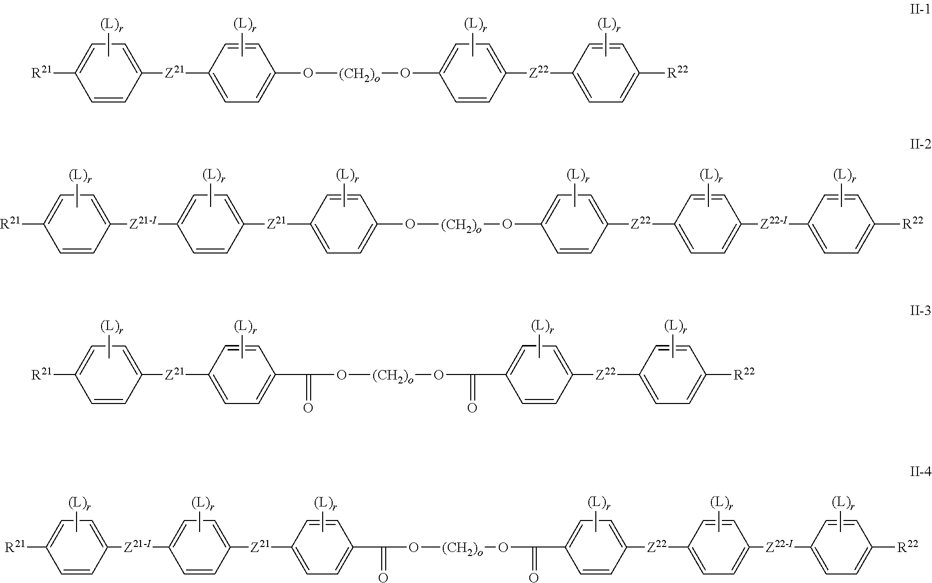

wherein R²¹ and R²² have the meanings given under formula II, Z²¹, Z²¹⁻¹ Z²² and Z²²⁻¹ are defined as X²¹ and X²² in formula II or are respectively the reverse groups of X²¹ and X²², and o and r are independently at each occurrence as defined above, including the preferred meanings of these groups and wherein L is as defined above, wherein compounds of formula I are excluded.

Particularly preferred mixtures according to the invention comprise one or more compounds of the formulae II-1a to II-1e and II-3a to II-3b.

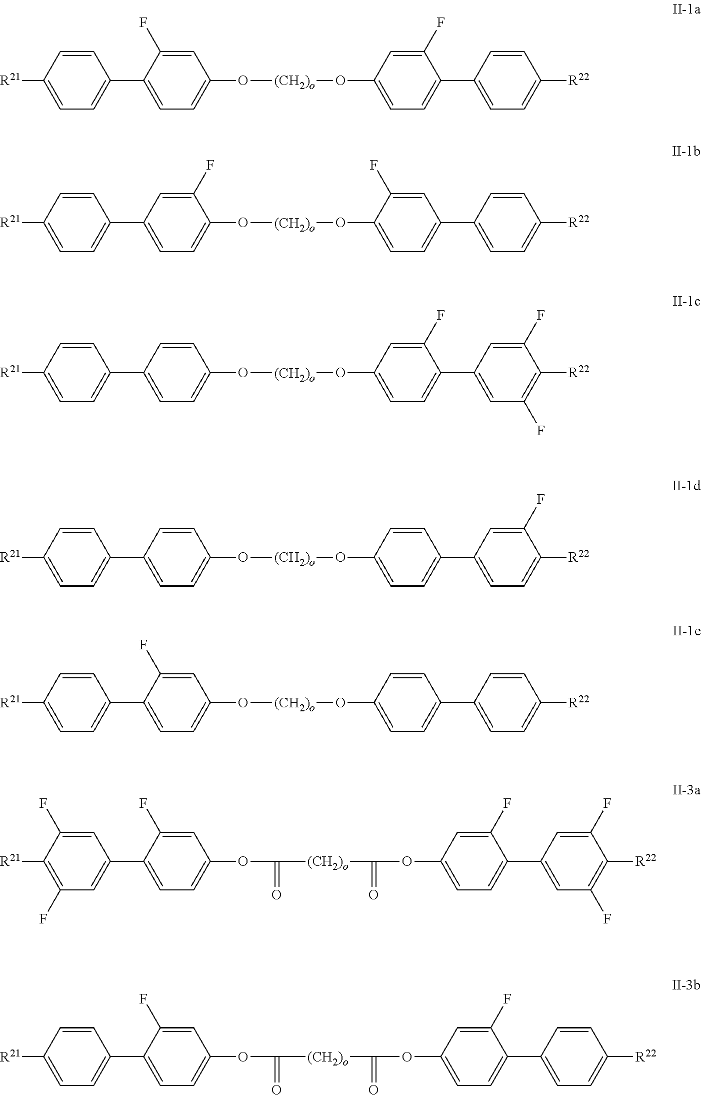

wherein R²¹, R²² and o are as defined above.

In a preferred embodiment of the invention the liquid crystalline medium is containing 2 to 25, preferably 3 to 15 compounds of formula II.

The amount of compounds of formula II in the liquid crystalline medium is preferably from 10 to 95%, more preferably from 15 to 90%, even more preferably from 20 to 85% by weight of the total mixture.

Preferably, the proportion of compounds of the formulae II-1a and/or II-1 b and/or II-1c and/or II-1e and/or II-3a and/or II-3b in the medium as a whole is preferably at least 70% by weight.

Particularly preferred media according to the invention comprise one or more chiral dopants, which themselves may or may not show a liquid crystalline phase and which themselves may or may not give good uniform alignment.

Especially preferred are chiral dopants selected from formula V

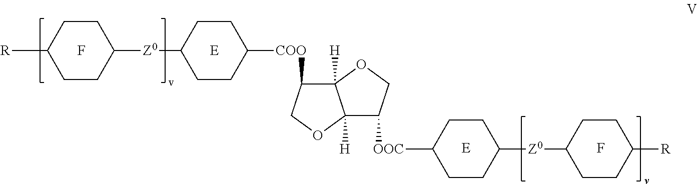

and formula VI

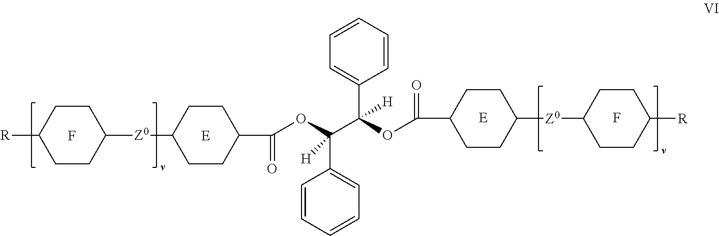

including the respective (S,S) enantiomer,
wherein E and F are each independently 1,4-phenylene or trans-1,4-cyclohexylene, v is 0 or 1, Z^{o} is —COO—, —OCO—, —CH₂CH₂— or a single bond, and R is alkyl, alkoxy or alkanoyl with 1 to 12 C atoms.

The compounds of formula V and their synthesis are described in WO 98/00428. Especially preferred is the compound CD-1, as shown in table D below. The compounds of formula VI and their synthesis are described in GB 2,328,207.

Especially preferred are chiral dopants with a high helical twisting power (HTP), in particular those disclosed in WO 98/00428.

Further typically used chiral dopants are e.g. the commercially available R/S-5011, CD-1, R/S-811 and CB-15 (from Merck KGaA, Darmstadt, Germany).

The above mentioned chiral compounds R/S-5011 and CD-1 and the compounds of formula V and VI exhibit a very high helical twisting power (HTP) and are therefore particularly useful in the present media.

The liquid crystalline medium preferably comprises 1 to 5, more preferably 1 to 3, even more preferably 1 or 2 chiral dopants, preferably selected from the above formula V, in particular CD-1, and/or formula VI and/or R-5011 or S-5011. Most preferably the chiral dopant is R-5011, S-5011 or CD-1.

The amount of chiral compounds in the liquid crystalline medium is preferably from 1 to 20% by weight of the total mixture, more preferably from 1 to 15% by weight, even more preferably from 1 to 10% by weight.

Further preferred are liquid crystalline media comprising one or more additives selected from the following formula VII

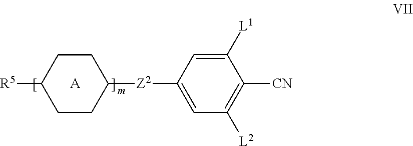

wherein

R⁵ is alkyl, alkoxy, alkenyl or alkenyloxy with up to 12 C atoms,

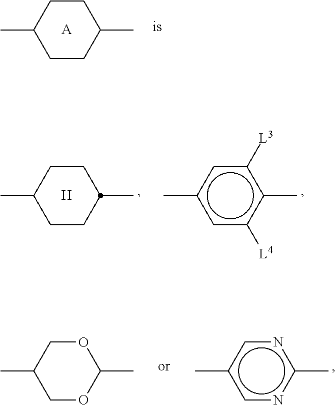

L¹ through L⁴ are each independently H or F,

Z² is —COO—, —CH₂CH₂— or a single bond, and

m is 1 or 2.

Particularly preferred compounds of formula VII are selected from the following formulae

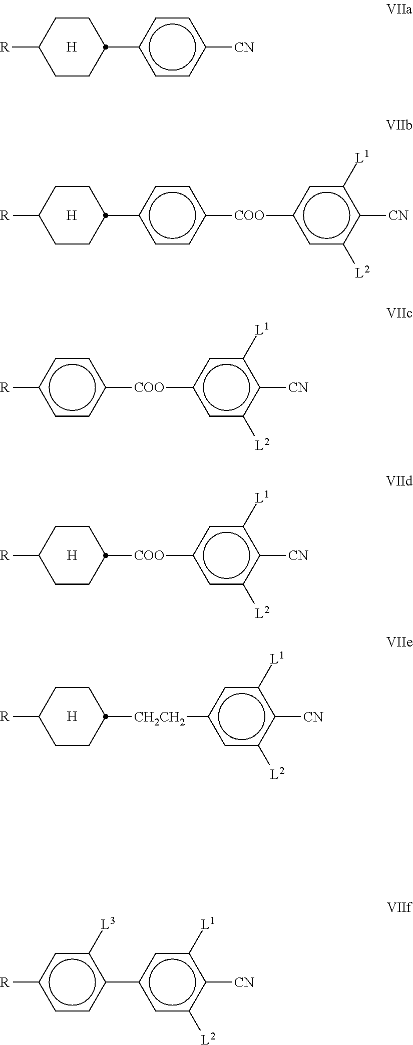

wherein R has one of the meanings as R⁵ above and L¹, L² and L³ have the above meanings.

The liquid crystalline medium preferably comprises 1 to 5, more preferably 1 to 3, even more preferably 1 or 2 compounds of formula VII, preferably selected from the above formulae VIIa to VIIf. The medium particularly preferably comprises one or more compounds selected from formulae VIIf.

The amount of suitable additives of formula VII in the liquid crystalline medium is preferably from 1 to 20% by weight of the total mixture, more preferably from 1 to 15% by weight, most preferably from 1 to 10% by weight.

The liquid crystal media according to the present invention may contain further additives in usual concentrations. The total concentration of these further constituents can be in the range of 0.1% to 10%, preferably 0.1% to 6%, based on the total mixture. The concentrations of the individual compounds used each are preferably in the range of 0.1% to 3%. The concentration of these further additives is not taken into consideration for the values and ranges of the concentrations of the liquid crystal components and compounds of the liquid crystal media in this application. This also holds for the concentration of dichroic dyes used in the mixtures, which are not counted when the concentrations of the compounds respectively the components of the host medium are specified. The concentration of the respective additives is always given relative to the final doped mixture.

The liquid crystal media according to the present invention each consist of several compounds, preferably of 3 to 30, more preferably of 4 to 20 and most preferably of 4 to 16 compounds. These compounds are mixed in a conventional way. As a rule, the required amount of the compound used in the smaller amount is dissolved in the compound used in the larger amount. In case the temperature is above the clearing point of the compound used in the higher concentration, it is particularly easy to observe completion of the process of dissolution. It is, however, also possible to prepare the media by other conventional ways, e.g. using so-called pre-mixtures, which can be e.g. homologous or eutectic mixtures of compounds or using so called multi-bottle systems, the constituents of which are ready-to-use mixtures themselves.

In an embodiment the liquid crystal medium is prepared by blending one or more compounds of formula I, one or more chiral dopants and one or more further bimesogenic compounds.

Particularly preferred mixture concepts are indicated below. The acronyms used are explained in Table A.

The mixtures according to the invention preferably comprise
one or more compounds of formula I in a total concentration in the range from 1 to 50%, more preferably from 5 to 40%, most preferably from 10 to 30% by weight of the total mixture
   and/or
one or more compounds of formula II in a total concentration in the range from 10 to 95%, more preferably from 15 to 90%, most preferably 20 to 85% by weight of the total mixture, preferably these compounds are selected from formulae II-1a to II-1e and II-3a to II-3b, more preferably comprising
   N-PGI-ZI-n-Z-GP-N, particularly preferably N-PGI-ZI-7-Z-GP-N and/or N-PGI-ZI-9-Z-GP-N, preferably in concentrations >5%, in particular 10-30%, based on the mixture as a whole,
and/or
   F-UIGI-ZI-n-Z-GU-F, particularly preferably F-UIGI-ZI-9-Z-GU-F, preferably in concentrations >5%, in particular 10-30%, based on the mixture as a whole,
and/or
   F-PGI-O-n-O—PP—N, particularly preferably F-PGI-O-9-O—PP—N, preferably in concentrations of ≥1%, in particular 1-20%, based on the mixture as a whole,
and/or
   N—PP-O-n-O-PG-OT, particularly preferably N—PP-O-7-O-PG-OT, preferably in concentrations of ≥5%, in particular 5-30%, based on the mixture as a whole,
and/or
   N—PP-O-n-O-GU-F, particularly preferably N—PP-O-9-O-GU-F, preferably in concentrations of ≥1%, in particular 1-20%, based on the mixture as a whole,
and/or
   F-PGI-O-n-O-GP-F, particularly preferably F-PGI-O-7-O-GP-F and/or F-PGI-O-9-O-GP-F, preferably in concentrations of ≥1%, in particular 1-20%, based on the mixture as a whole,
and/or
   N-GIGIGI-n-GGG-N, in particular N-GIGIGI-9-GGG-N, preferably in concentrations >5%, in particular 10-30%, based on the mixture as a whole,
and/or
   N-PGI-n-GP-N, particularly preferably N-PGI-9-GP-N, preferably in concentrations >5%, in particular 15-50%, based on the mixture as a whole,
and/or
one or more suitable additives of formula VII in a total concentration in the range from 1 to 20%, more preferably from 1 to 15%, most preferably from 1 to 10% by weight of the total mixture, wherein preferably these compounds are selected from formula VIIa to VIIf, more preferably comprising
   PP-n-N, preferably in concentrations of ≥1%, in particular 1-20%, based on the mixture as a whole,
and/or
one or more chiral compounds, preferably in a total concentration in the range from 1 to 20%, more preferably from 1 to 15%, even more preferably from 1 to 10% by weight of the total mixture, wherein preferably these compounds are selected from formula V, VI, and R-5011 or S-5011, more preferably comprising
   R-5011, S-5011 or CD-1, preferably in a concentration of ≥1%, in particular 1-20%, based on the mixture as a whole.

The bimesogenic compounds of formula I and the liquid crystalline media comprising them can be used in liquid crystal displays, such as STN, TN, AMD-TN, temperature compensation, guest-host, phase change or surface stabilized or polymer stabilized cholesteric texture (SSCT, PSCT) displays, in particular in flexoelectric devices, in active and passive optical elements like polarizers, compensators, reflectors, alignment layers, colour filters or holographic elements, in adhesives, synthetic resins with anisotropic mechanical properties, cosmetics, diagnostics, liquid crystal pigments, for decorative and security applications, in nonlinear optics, optical information storage or as chiral dopants.

The compounds of formula I and the mixtures obtainable thereof are particularly useful for flexoelectric liquid crystal displays.

A further aspect of the present invention thus is a liquid crystal device comprising a liquid crystalline medium which comprises two or more components, wherein one or more of the components is the bimesogenic compound according to the invention.

Preferably, the device is a flexoelectric device.

The inventive bimesogenic compounds of formula I and the mixtures thereof can be aligned in their cholesteric phase into different states of orientation by methods that are known to the skilled person, such as surface treatment or electric fields. For example, they can be aligned into the planar (Grandjean) state, into the focal conic state or into the homeotropic state. Inventive compounds of formula I comprising polar groups, in particular with a strong dipole moment, can further be subjected to flexoelectric switching, and can thus favourably be used in electro-optical switches or liquid crystal displays.

The switching between different states of orientation according to a preferred embodiment of the present invention is exemplarily described below in detail for a sample comprising an inventive compound of formula I.

According to this preferred embodiment, the sample is placed into a cell comprising two plane-parallel glass plates coated with electrode layers, e.g. ITO layers, and aligned in its cholesteric phase into a planar state, wherein the axis of the cholesteric helix is oriented normal to the cell walls. This state is also known as Grandjean state, and the texture of the sample, which is observable e.g. in a polarization microscope, as Grandjean texture. Planar alignment can be achieved e.g. by surface treatment of the cell walls, for example by rubbing and/or coating with an alignment layer such as polyimide.

A Grandjean state with a high quality of alignment and only few defects can further be achieved by heating the sample to the isotropic phase, subsequently cooling to the chiral nematic phase at a temperature close to the chiral nematic-isotropic phase transition, and rubbing the cell.

In the planar state, the sample shows selective reflection of incident light, with the central wavelength of reflection depending on the helical pitch and the mean refractive index of the material.

When an electric field is applied to the electrodes, for example with a frequency from 10 Hz to 1 kHz and an amplitude of up to 12 Vᵣₘₛ/μm, the sample is being switched into a homeotropic state where the helix is unwound and the molecules are oriented parallel to the field, i.e. normal to the plane of the electrodes. In the homeotropic state, the sample is transmissive when viewed in normal daylight, and appears black when being put between crossed polarizers.

Upon reduction or removal of the electric field in the homeotropic state, the sample adopts a focal conic texture, where the molecules exhibit a helically twisted structure with the helical axis being oriented perpendicular to the field, i.e. parallel to the plane of the electrodes. A focal conic state can also be achieved by applying only a weak electric field to a sample in its planar state. In the focal conic state the sample is scattering when viewed in normal daylight and appears bright between crossed polarizers.

A sample comprising an inventive compound in the different states of orientation exhibits different transmission of light. Therefore, the respective state of orientation, as well as its quality of alignment, can be examined by measuring the light transmission of the sample depending on the strength of the applied electric field. Thereby it is also possible to determine the electric field strength required to achieve specific states of orientation and transitions between these different states.

In a sample comprising an inventive compound of formula I, the above described focal conic state consists of many disordered birefringent small domains. By applying an electric field greater than the field for nucleation of the focal conic texture, preferably with additional shearing of the cell, a uniformly aligned texture is obtainable where the helical axis is parallel to the plane of the electrodes in large, well-aligned areas. In accordance with the literature on state of the art chiral nematic materials, such as P. Rudquist et al., Liq. Cryst. 23 (4), 503 (1997), this texture is also called uniformly lying helix (ULH) texture. This texture is suited to characterize the flexoelectric properties of the inventive compounds.

The sequence of textures typically observed in a sample comprising an inventive compound of formula I on a rubbed polyimide substrate upon increasing or decreasing the electric field is given below:

Starting from the ULH texture, the inventive flexoelectric compounds and mixtures can be subjected to flexoelectric switching by application of an electric field. This causes rotation of the optic axis of the material in the plane of the cell substrates, which leads to a change in transmission when placing the material between crossed polarizers. The flexoelectric switching of inventive materials is further described in detail in the background of the invention above and in the Examples.

It is also possible to obtain the ULH texture starting from the focal conic texture by applying an electric field with a high frequency, of for example 10 kHz, to the sample whilst cooling slowly from the isotropic phase into the cholesteric phase and shearing the cell. The field frequency may differ for different compounds.

The bimesogenic compounds of formula I are particularly useful in flexoelectric liquid crystal displays as they can easily be aligned into macroscopically uniform orientation, and can lead to favourable values of the elastic constant k₁₁ and a high flexoelectric coefficient e in the liquid crystal medium.

The liquid crystal medium preferably exhibits a k₁₁<1×10⁻¹⁰ N, preferably <2×10⁻¹¹ N, and a flexoelectric coefficient e>1×10⁻¹¹ C/m, preferably >1×10⁻¹⁰ C/m.

Besides the use in flexoelectric devices, the inventive bimesogenic compounds as well as mixtures thereof are also suitable for other types of displays and other optical and electro-optical applications, such as optical compensation or polarizing films, colour filters, reflective cholesterics, optical rotatory power systems and optical information storage.

In a further embodiment a display cell wherein the cell walls exhibit hybrid alignment conditions is provided. The term “hybrid alignment” or orientation of a liquid crystal or mesogenic material in a display cell or between two substrates means that the mesogenic groups adjacent to the first cell wall or on the first substrate exhibit homeotropic orientation and the mesogenic groups adjacent to the second cell wall or on the second substrate exhibit planar orientation.

The term “homeotropic alignment” or orientation of a liquid crystal or mesogenic material in a display cell or on a substrate means that the mesogenic groups in the liquid crystal or mesogenic material are oriented substantially perpendicular to the plane of the cell or substrate, respectively.

The term “planar alignment” or orientation of a liquid crystal or mesogenic material in a display cell or on a substrate means that the mesogenic groups in the liquid crystal or mesogenic material are oriented substantially parallel to the plane of the cell or substrate, respectively.

A flexoelectric display according to a preferred embodiment of the present invention comprises two plane parallel substrates, preferably glass plates covered with a transparent conductive layer such as indium tin oxide (ITO) on their inner surfaces, and the flexoelectric liquid crystalline medium provided between the substrates, wherein one of the inner substrate surfaces exhibits homeotropic alignment conditions and the opposite inner substrate surface exhibits planar alignment conditions for the liquid crystalline medium.

Planar alignment can be achieved e.g. by means of an alignment layer, for example a layer of rubbed polyimide or sputtered SiOₓ, which is applied on the substrate.

Alternatively, it is possible to directly rub the substrate, i.e. without applying an additional alignment layer. For example, rubbing can be achieved by means of a rubbing cloth, such as a velvet cloth, or with a flat bar coated with a rubbing cloth. In a preferred embodiment of the present invention rubbing is achieved by means of at least one rubbing roller, like e.g. a fast spinning roller that is brushing across the substrate, or by putting the substrate between at least two rollers, wherein in each case at least one of the rollers is optionally covered with a rubbing cloth. In another preferred embodiment of the present invention rubbing is achieved by wrapping the substrate at least partially at a defined angle around a roller that is preferably coated with a rubbing cloth.

Homeotropic alignment can be achieved e.g. by means of an alignment layer coated on top of the substrate. Suitable aligning agents used on glass substrates are for example alkyltrichlorosilane or lecithine, whereas for plastic substrates thin layers of lecithine, silica or high tilt polyimide orientation films as aligning agents may be used. In a preferred embodiment of the invention a silica coated plastic film is used as a substrate.

Further suitable methods to achieve planar or homeotropic alignment are described for example in J. Cognard, Mol. Cryst. Liq. Cryst. 78, Supplement 1, 1-77 (1981).

By using a display cell with hybrid alignment conditions, a very high switching angle of flexoelectric switching, fast response times and a good contrast can be obtainable.

The flexoelectric display according to the present invention may also comprise plastic substrates instead of glass substrates. Plastic film substrates are particularly suitable for rubbing treatment by rubbing rollers as described above.

When added to a nematic liquid crystalline mixture the compounds of formula I may produce a phase below the nematic. Accordingly, the bimesogenic compounds according to the present invention can allow the second nematic phase to be induced in nematic mixtures that do not show evidence of this phase normally. Furthermore, varying the amounts of compounds of formula I may allow the phase behaviour of the second nematic to be tailored to the required temperature.

Therefore, in an embodiment a liquid crystal medium is provided comprising one or more compounds of formula I and exhibiting a second nematic phase. These obtainable mixtures are particularly useful for flexoelectric liquid crystal display.

The total concentration of all compounds in the media according to this application is 100%.

In the foregoing and in the following examples, unless otherwise indicated, all temperatures are set forth uncorrected in degrees Celsius and all parts and percentages are by weight.

The following abbreviations are used to illustrate the liquid crystalline phase behaviour of the compounds: K=crystalline; N=nematic; N2=second nematic; S or Sm=smectic; Ch=cholesteric; I=isotropic; T_{g}=glass transition temperature. The numbers between the symbols indicate the phase transition temperatures in ° C.

In the present invention and especially in the following examples, the structures of the liquid crystal compounds are represented by abbreviations, which are also called “acronyms”. The transformation of the abbreviations into the corresponding structures is straight-forward according to the following three tables A to C.

All groups CₙH₂ₙ₊₁, CₘH₂ₘ₊₁, and CₗH₂ₗ₊₁ are preferably straight chain alkyl groups with n, m and l C atoms, respectively, all groups CₙH₂ₙ, CₘH₂ₘ and CₗH₂ₗ are preferably (CH₂)ₙ, (CH₂)ₘ and (CH₂)ₗ, respectively and —CH═CH— preferably is trans-respectively E-vinylene.

Table A lists the symbols used for the ring elements, table B those for the linking groups and table C those for the symbols for the left hand and the right hand end (terminal) groups of the molecules.

Table D lists exemplary molecular structures together with their respective codes.

TABLE A
Ring Elements

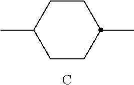

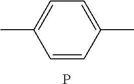

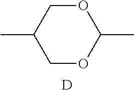

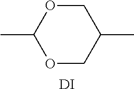

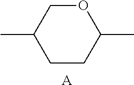

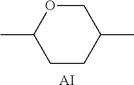

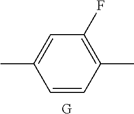

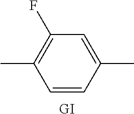

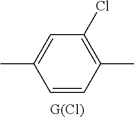

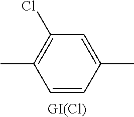

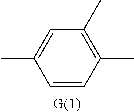

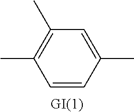

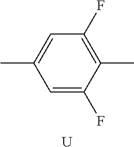

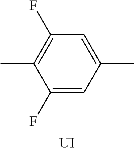

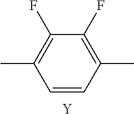

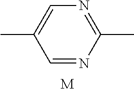

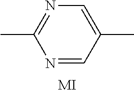

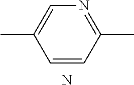

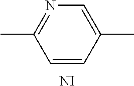

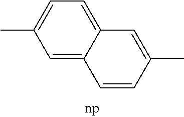

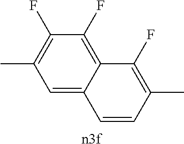

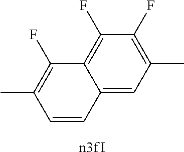

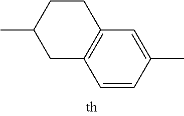

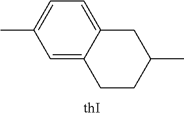

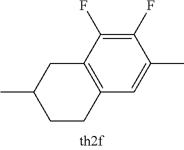

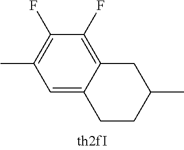

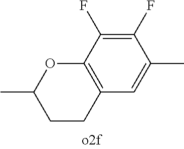

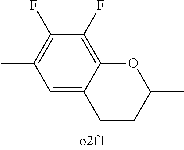

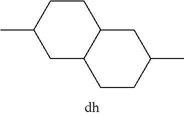

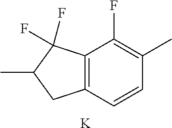

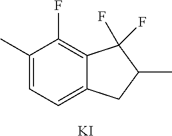

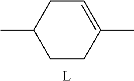

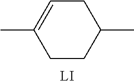

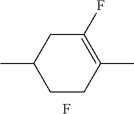

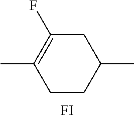

TABLE B
Linking Groups

| n | (—CH₂—)ₙ | “n” is an integer except 0 and 2 | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| 1O | —CH₂—O— | O1 | —O—CH₂— |
| Q | —CF₂—O— | QI | —O—CF₂— |

TABLE C
End Groups

| Left hand side, used alone or in | | Right hand side, used alone or | |
|---|---|---|---|
| combination with others | | in combination with others | |
| -n- | CₙH₂ₙ₊₁— | -n | —CₙH₂ₙ₊₁ |
| m- | CₘH₂ₘ₊₁— (for bimeso- | -k | —CₖH₂ₖ₊₁ (for bimeso- |
| | genic compounds) | | genic compounds) |
| -nO- | CₙH₂ₙ₊₁—O— | -nO | —O—CₙH₂ₙ₊₁ |
| -V- | CH₂═CH— | -V | —CH═CH₂ |
| -nV- | CₙH₂ₙ₊₁—CH═CH— | -nV | —CₙH₂ₙ—CH═CH₂ |
| -Vn- | CH₂═CH—CₙH₂ₙ— | -Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| -N- | N≡C— | -N | —C≡N |
| -S- | S═C═N— | -S | —N═C═S |
| -F- | F— | -F | —F |
| -CL- | Cl— | -CL | —Cl |
| -M- | CFH₂— | -M | —CFH₂ |
| -D- | CF₂H— | -D | —CF₂H |
| -T- | CF₃— | -T | —CF₃ |
| -MO- | CFH₂O— | -OM | —OCFH₂ |
| -DO- | CF₂HO— | -OD | —OCF₂H |
| -TO- | CF₃O— | -OT | —OCF₃ |
| -A- | H—C≡C— | -A | —C≡C—H |
| -nA- | CₙH₂ₙ₊₁—C≡C— | -An | —C≡C—CₙH₂ₙ₊₁ |
| -NA- | N≡C—C≡C— | -AN | —C≡C—C≡N |
| Left hand side, used in | | Right hand side, used in | |
| combination with others only | | combination with others only | |
| -. . . n. . . - | (—CH₂—)n | -. . . n. . . | (—CH₂—)ₙ |
| -. . . M. . . - | —CFH— | -. . . M. . . | —CFH— |
| -. . . D. . . - | —CF₂— | -. . . D. . . | —CF₂— |
| -. . . V. . . - | —CH═CH— | -. . . V. . . | —CH═CH— |
| -. . . Z. . . - | —CO—O— | -. . . Z. . . | —CO—O— |
| -. . . ZI. . . - | —O—CO— | -. . . ZI. . . | —O—CO— |
| -. . . K. . . - | —CO— | -. . . K. . . | —CO— |
| -. . . W. . . - | —CF═CF— | -. . . W. . . | —CF═CF— |

wherein n, m and k each are integers and three points “...” indicate a space for other symbols of this table.

Preferably, the liquid crystalline media according to the present invention comprise, besides the compound(s) of formula I, one or more compounds selected from the group of compounds of the formulae of the following table.

TABLE D

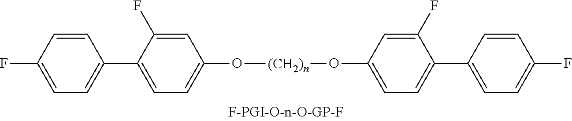

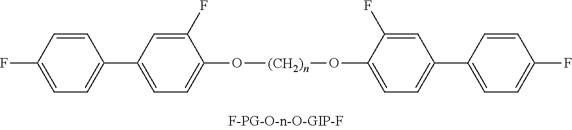

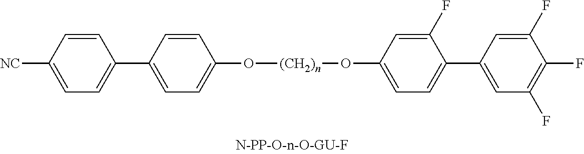

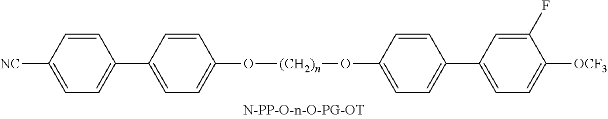

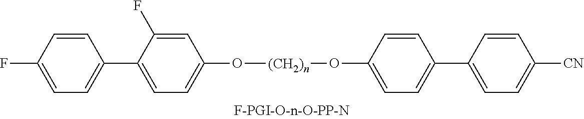

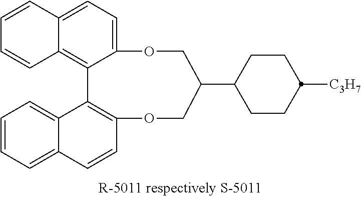

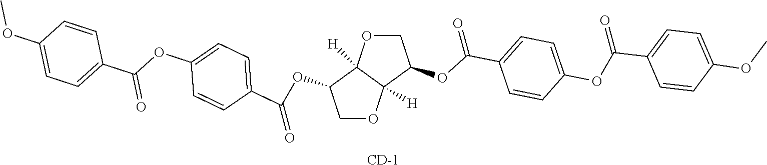

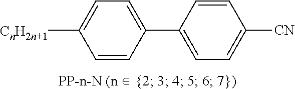

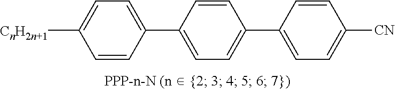

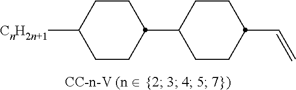

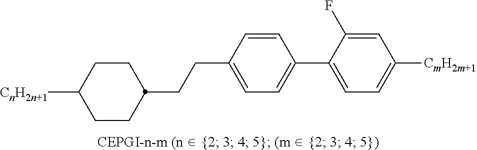

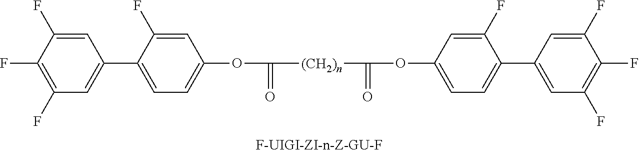

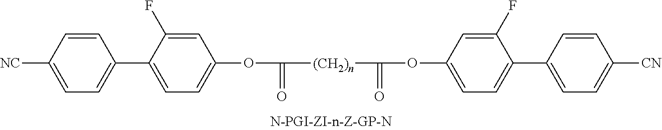

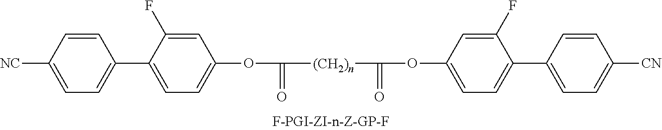

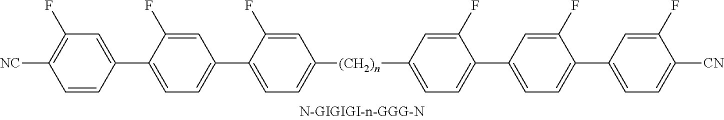

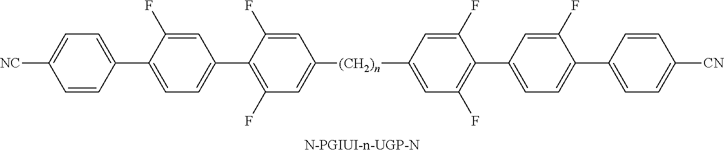

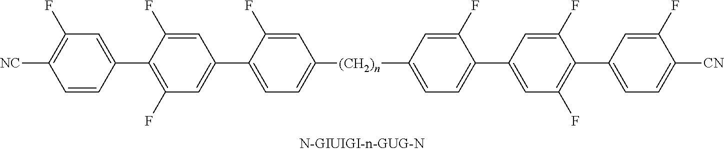

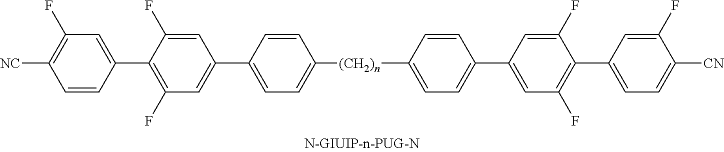

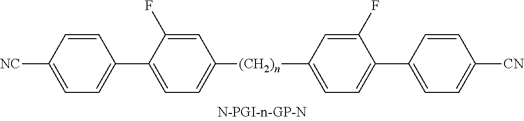

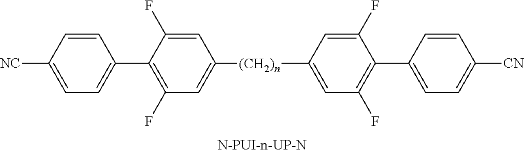

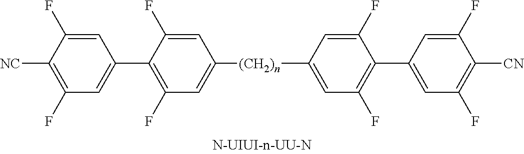

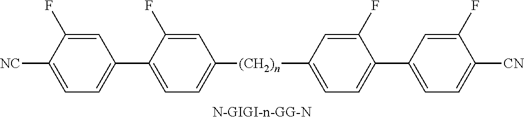

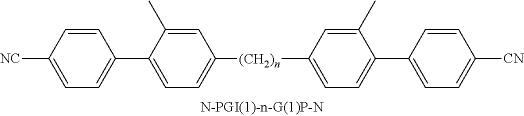

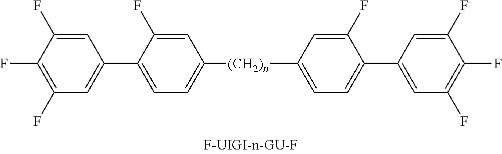

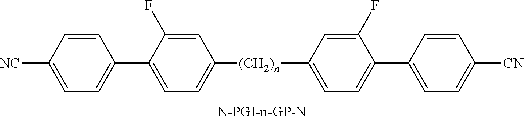

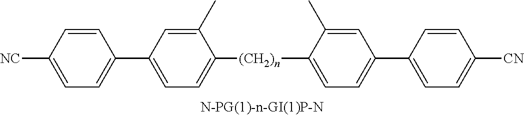

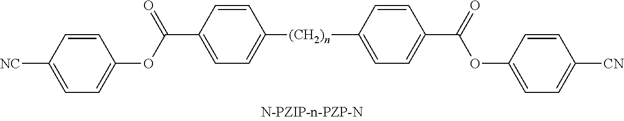

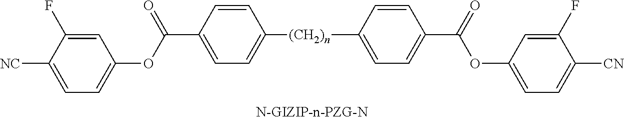

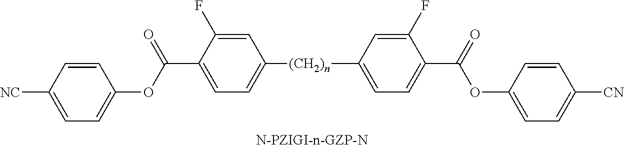

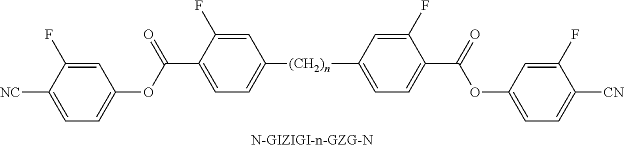

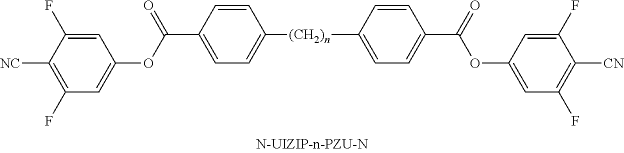

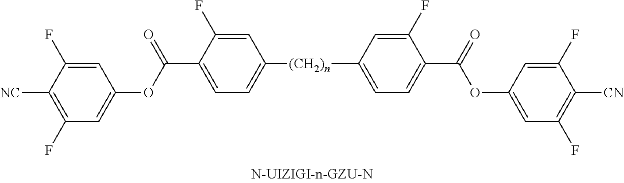

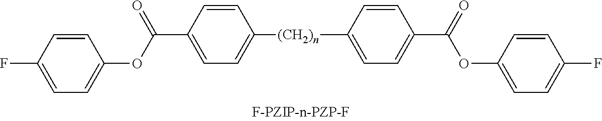

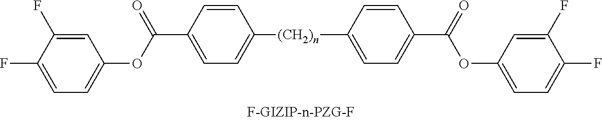

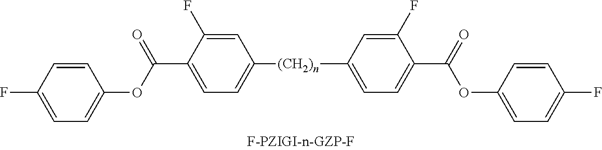

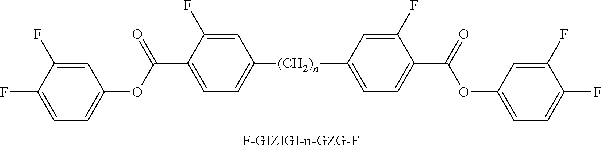

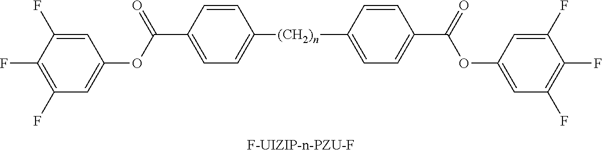

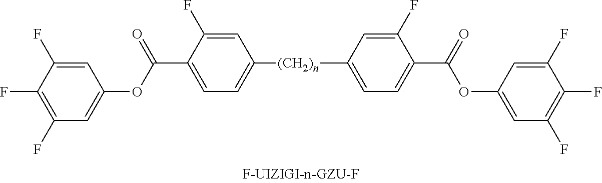

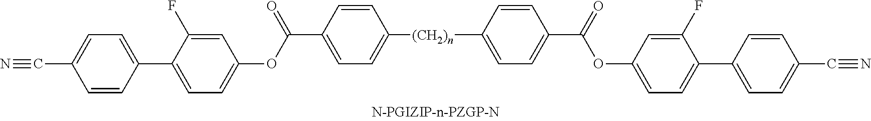

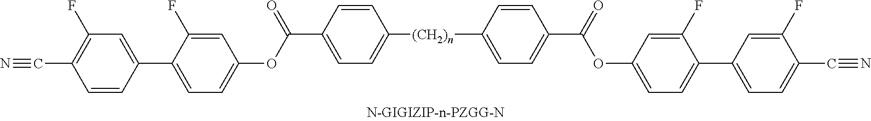

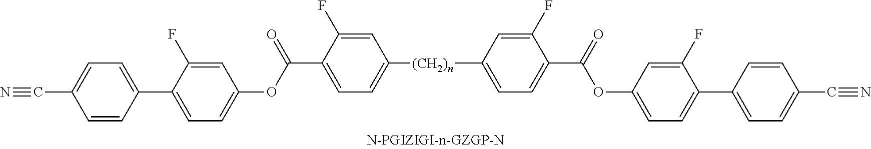

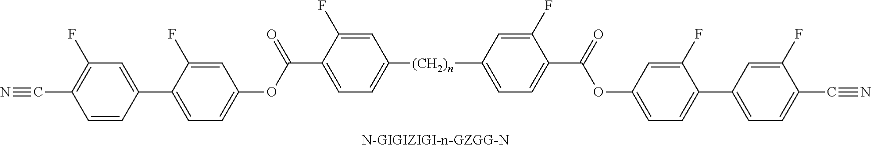

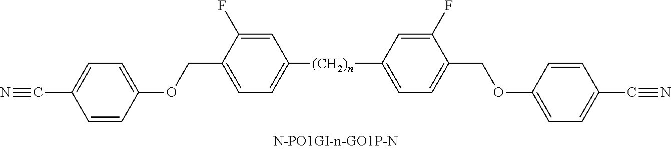

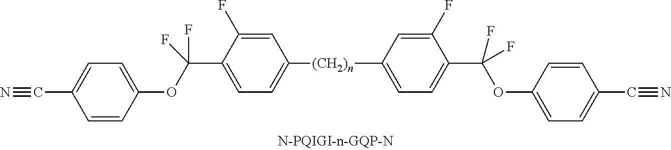

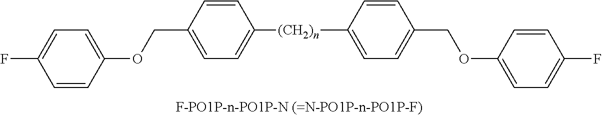

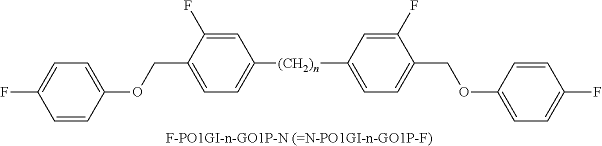

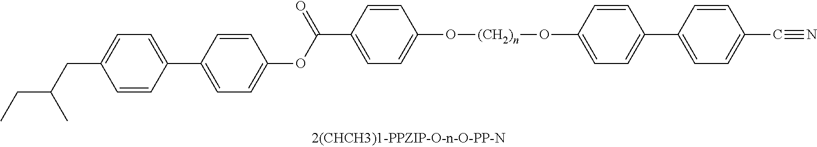

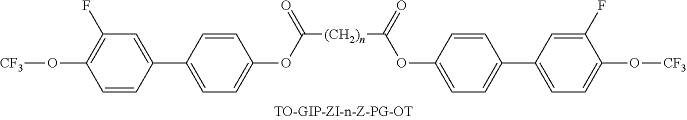

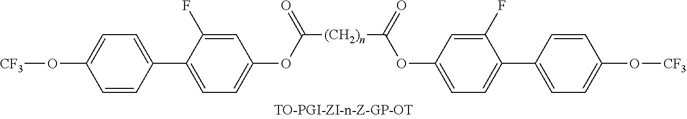

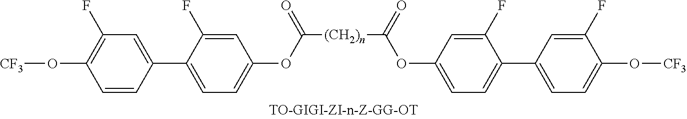

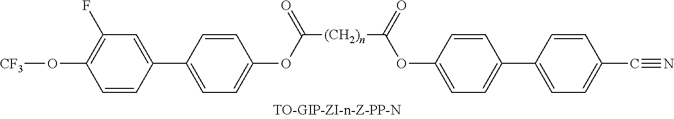

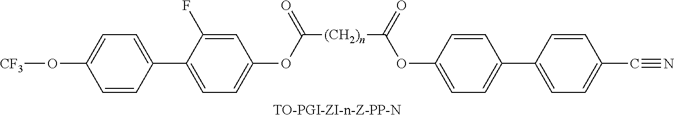

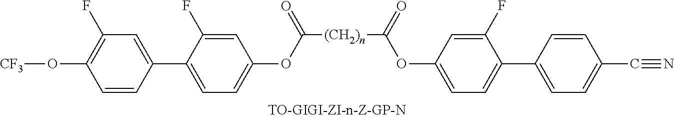

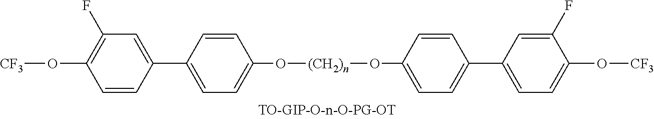

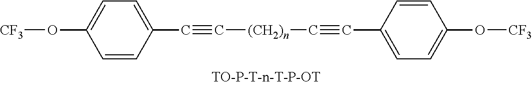

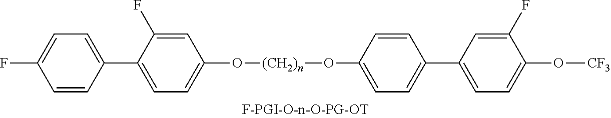

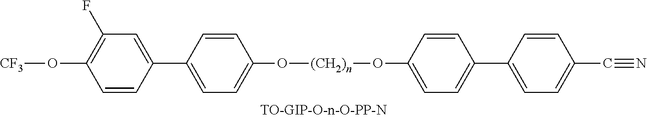

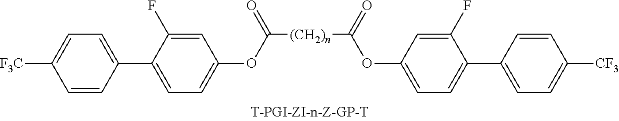

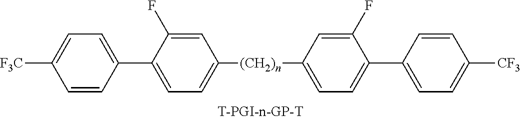

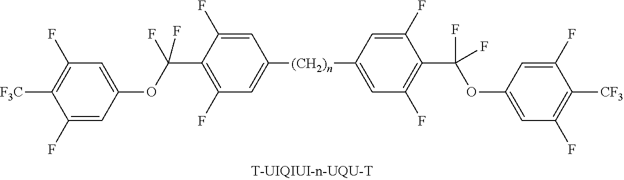

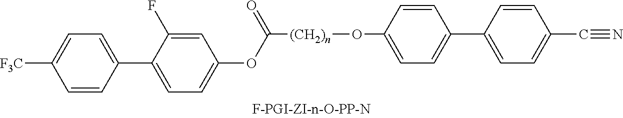

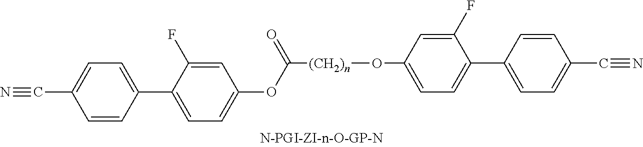

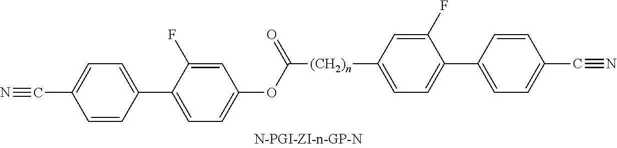

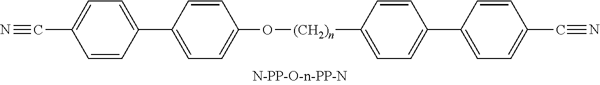

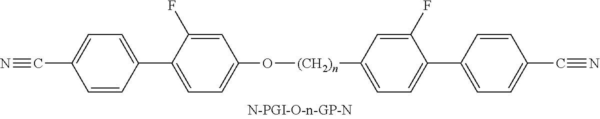

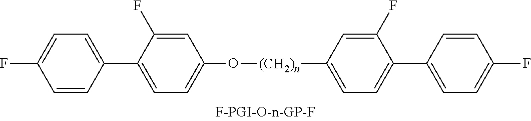

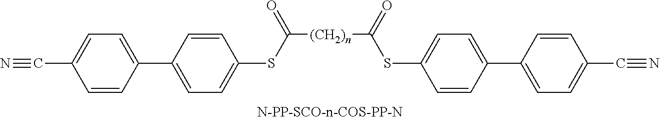

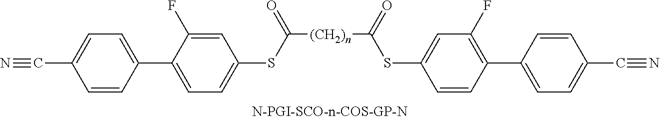

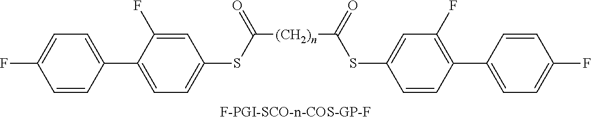

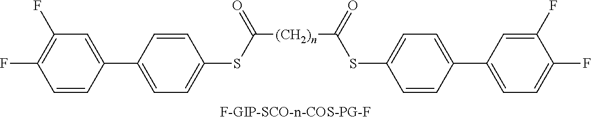

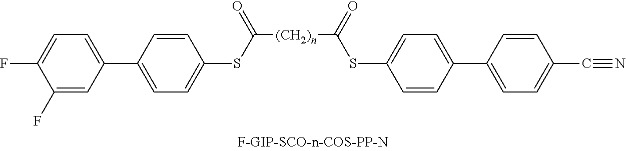

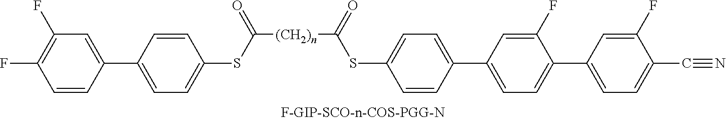

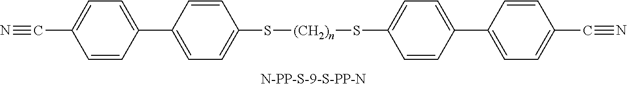

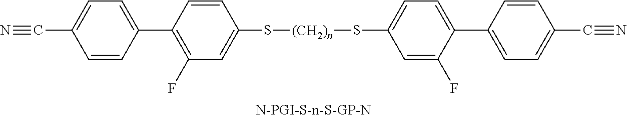

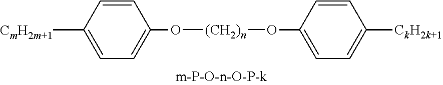

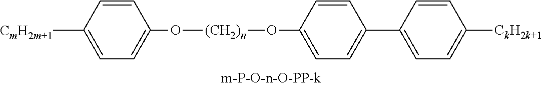

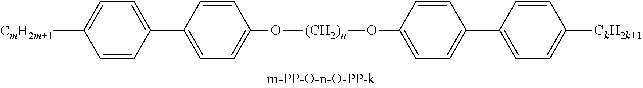

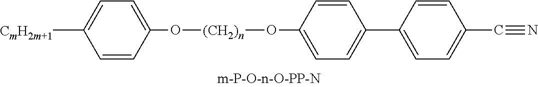

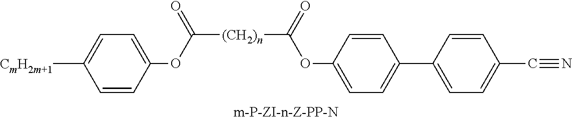

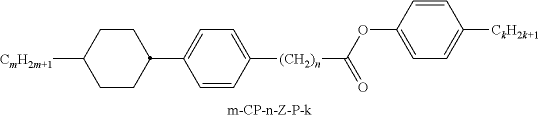

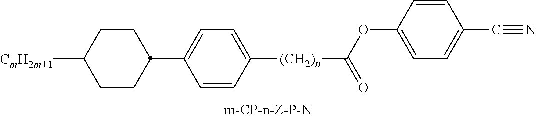

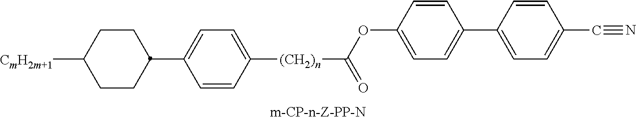

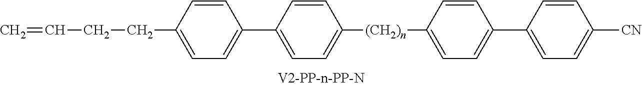

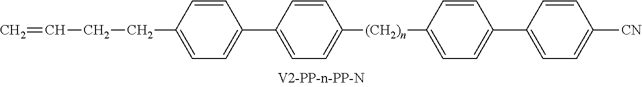

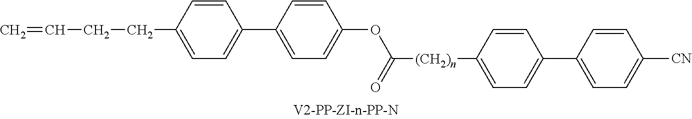

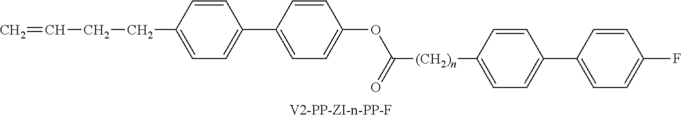

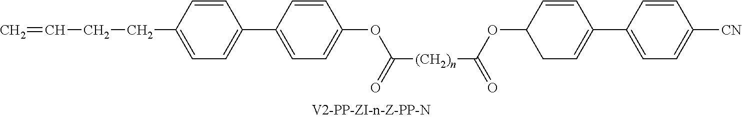

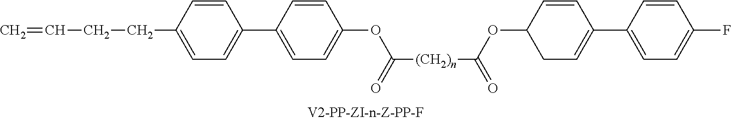

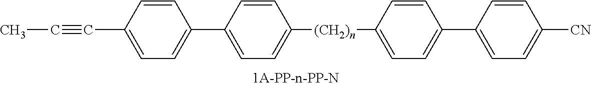

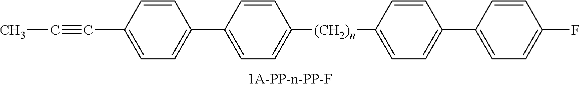

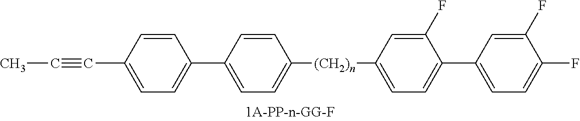

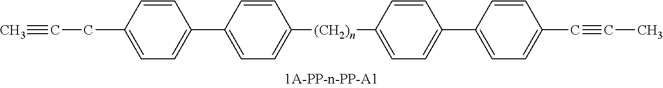

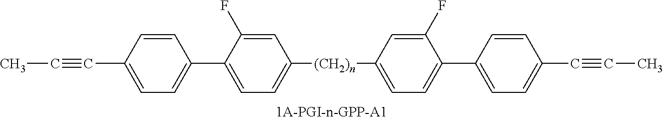

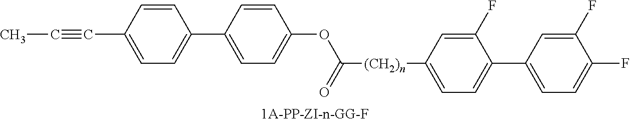

In this table n is an integer selected from 3 and 5 to 15, preferably from 3, 5, 7 and 9, unless explicitly defined otherwise, and m and k are independently of each other an integer from 1 to 9, preferably from 1 to 7, more preferably from 3 to 5.

The following examples are merely illustrative of the present invention and they should not be considered as limiting the scope of the invention in any way. The examples and modifications or other equivalents thereof will become apparent to those skilled in the art in the light of the present disclosure.

### COMPOUND AND SYNTHESIS EXAMPLES

### Synthesis Example 1

Preparation of

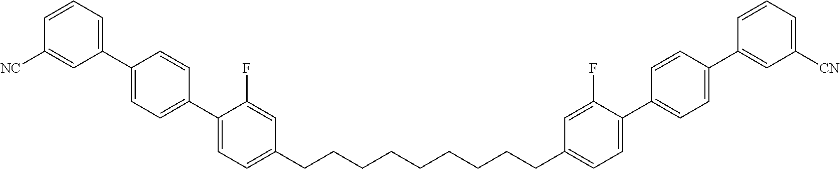 [SMILES: N#Cc1cccc(-c2ccc(-c3ccc(CCCCCCCCCc4ccc(-c5ccc(-c6cccc(C#N)c6)cc5)c(F)c4)cc3F)cc2)c1]

The compound of interest is prepared according to the following scheme.

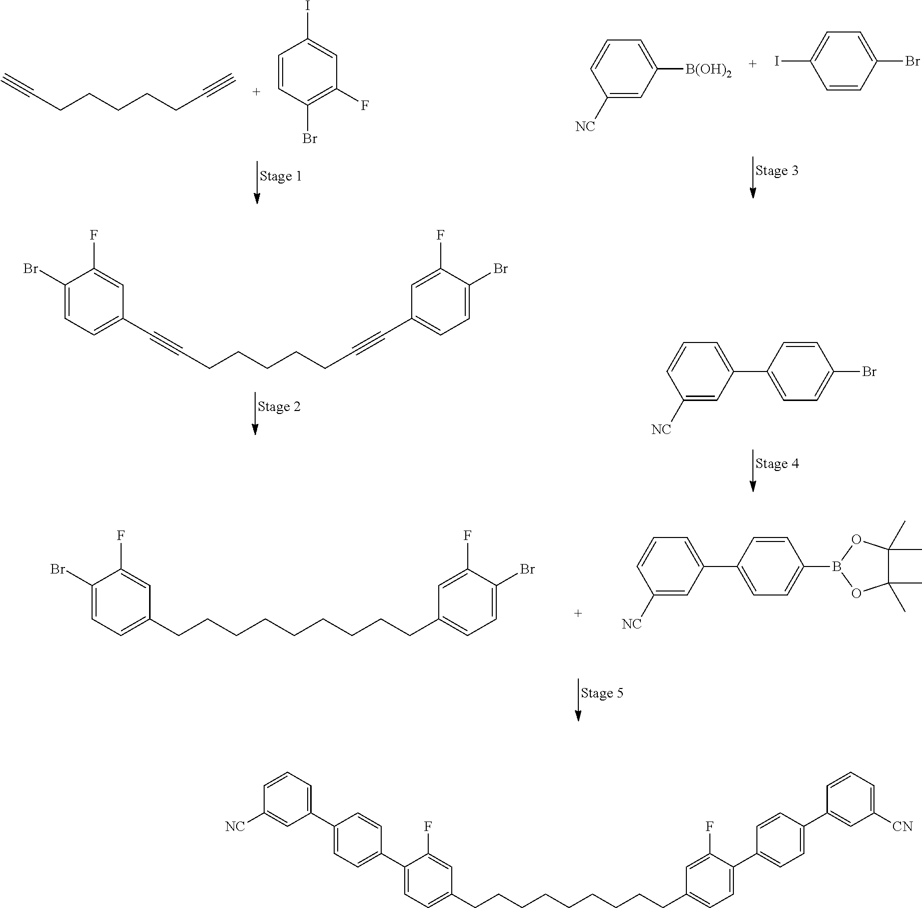

Stage 4

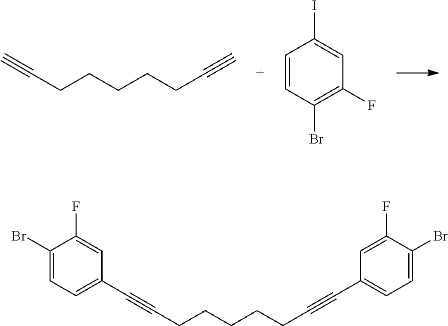

1-bromo-3-fluoroiodobenzene (27.5 g, 0.092 mol) is added to a round bottom flask containing tetrahydrofuran (30 mL). Diisopropylamine (30 mL) is added and the reaction is placed in an ultrasonic bath for 10 minutes. Catalysts, bis(triphenylphosphine)palladium(II) dichloride (0.9 g, 1.28 mmol) and copper (I) iodide (0.2 g, 1.05 mmol) are added and the reaction is cooled in a water bath to 20° C. 1,8-Nonadiyne (5.0 g, 0.041 mol) is slowly added to the reaction and stirred for a further 20 hours. The reaction is cooled and filtered under vacuum to remove precipitates. The filtrate is acidified with dilute hydrochloric acid and extracted with diethyl ether. The organic material is washed with water before concentrating to afford the product as a black solid. Pure product is obtained after column chromatography, eluting with dichloromethane/petroleum ether.

Stage 2

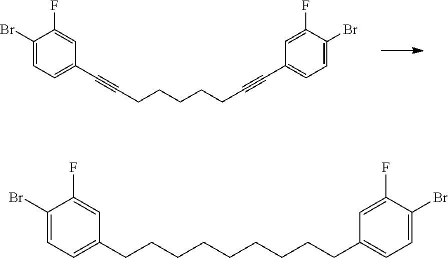 [SMILES: Fc1cc(C#CCCCCCC#Cc2ccc(Br)c(F)c2)ccc1Br ; Fc1cc(CCCCCCCCCc2ccc(Br)c(F)c2)ccc1Br]

Product of stage 1 (21.5 g, 0.040 mol) is dissolved in tetrahydrofuran (600 mL) and passed through a Thalesnano hydrogenator. Conditions of 70 bar pressure and 60° C. are used to produce the product as pale coloured solid.

Stage 3

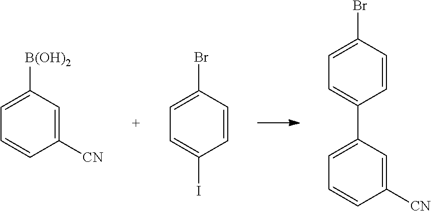 [SMILES: N#Cc1cccc(B(O)O)c1 ; Brc1ccc(I)cc1 ; N#Cc1cccc(-c2ccc(Br)cc2)c1]

1-Bromo-4-iodo-benzene (17.33 g; 61.25 mmol), (3-cyanophenyl)boronic acid (9.00 g; 61.25 mmol) are charged in a flask containing 400 mL tetrahyrofuran under nitrogen. Potassium carbonate (12.70 g; 91.87 mmol) in 20 mL water is added. The system is degassed and bis(triphenylphosphine)palladium(II) dichloride (0.90 g; 1.28 mmol; 0.02 eq.) is added. The reaction mixture is stirred at 80° C. overnight. Water (50 mL) and 20 mL dilute hydrochloric acid are added. Organic phase is separated and aqueous phase is extracted with ethyl acetate (3×100 mL). Organic phases are combined, dried over magnesium sulphate and evaporated under reduced pressure. Purification by plug of silica eluted by dichloromethane followed by crystallisation from IMS gives pure product.

Stage 4

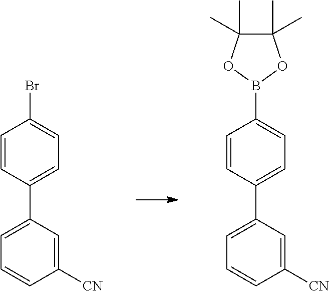 [SMILES: N#Cc1cccc(-c2ccc(Br)cc2)c1 ; CC1(C)OB(c2ccc(-c3cccc(C#N)c3)cc2)OC1(C)C]

4′-Bromo-biphenyl-3-carbonitrile (10.50 g; 40.68 mmol), 4,4,5,5,4′,4′,5′,5′-octamethyl-[2,2′]bi[[1,3,2]dioxaborolanyl] (11.36 g; 44.75 mmol) and potassium acetate (5.94 g; 60.65 mmol) are added to 200 mL anhydrous 1,4-dioxane. The system is degassed, dichlorobis(tricyclohexylphosphine)palladium (II) (1.50 g; 2.03 mmol) is added and the reaction mixture is stirred at 80° C. overnight. Water (30 mL) is added and organic phase is separated. Aqueous phase is extracted three times with ethyl acetate. Organic phases are combined and washed with brine, then twice with water, dried over magnesium sulphate and concentrated. Purification by column chromatography over silica gel eluted with petroleum ether/dichloromethane (5:1 ratio), followed by recrystallisation from petroleum ether/IMS gives pure product as white solid.

Stage 5

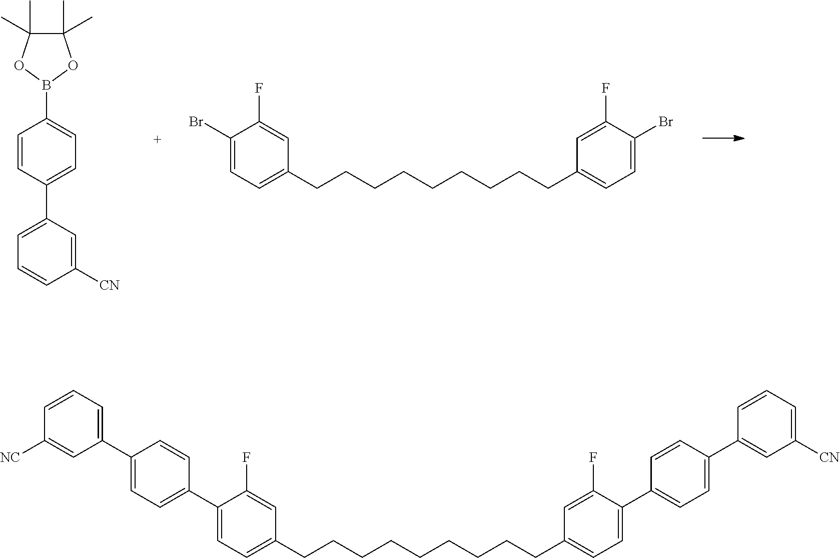 [SMILES: CC1(C)OB(c2ccc(-c3cccc(C#N)c3)cc2)OC1(C)C ; Fc1cc(CCCCCCCCCc2ccc(Br)c(F)c2)ccc1Br ; N#Cc1cccc(-c2ccc(-c3ccc(CCCCCCCCCc4ccc(-c5ccc(-c6cccc(C#N)c6)cc5)c(F)c4)cc3F)cc2)c1]

To a solution of 4′-(4,4,5,5-tetramethyl-[1,3,2]dioxaborolan-2-yl)-biphenyl-3-carbonitrile (9.65 g; 31.63 mmol) and 1-bromo-4-[9-(4-bromo-3-fluoro-phenyl)nonyl]-2-fluoro-benzene (7.50 g; 15.82 mmol) in 100 mL tetrahydrofuran, sodium metaborate octahydrate (6.83 g; 24.78 mmol) in 20 mL water is added. The system is purged with nitrogen and bis(triphenylphosphine)palladium(II) dichloride (0.28 g; 0.40 mmol) is added and the reaction mixture is stirred at 80° C. overnight. Water (20 mL) is added and organic phase is separated. Aqueous phase is extracted with ethyl acetate. Organic phases are combined, washed with dilute hydrochloric acid followed by water and evaporated under reduced pressure. Crystallisation from dichloromethane/acetonitrile gives pure product.

Phase sequence: K 124 I, e/K=1.96 V⁻¹.

### Synthesis Example 2

### Synthesis Example 2a

Preparation of

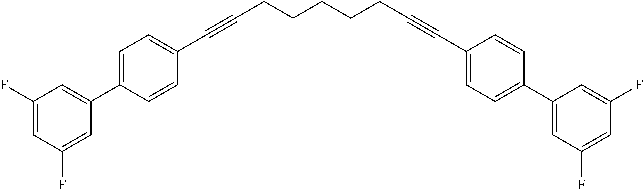 [SMILES: Fc1cc(F)cc(-c2ccc(C#CCCCCCC#Cc3ccc(-c4cc(F)cc(F)c4)cc3)cc2)c1]

The compound of interest is prepared according to the following scheme.

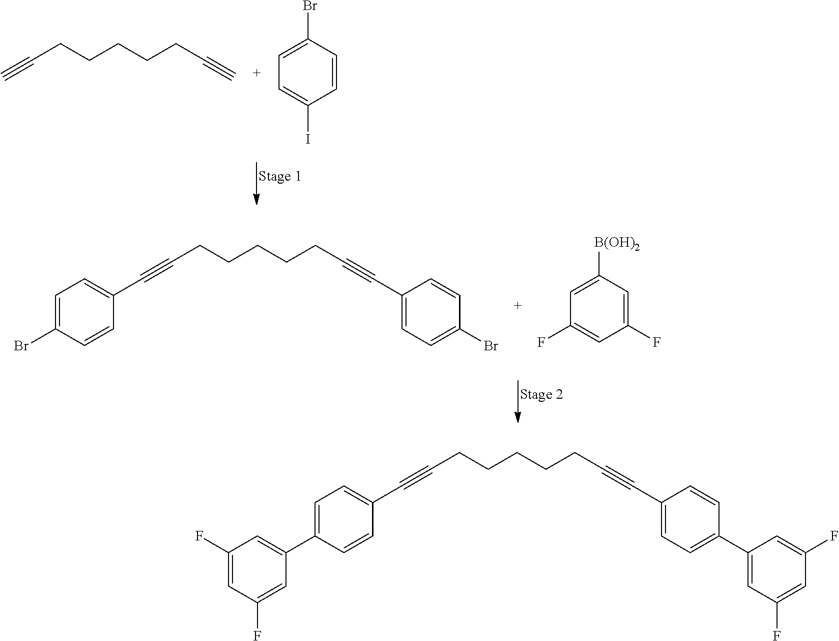

Stage 1

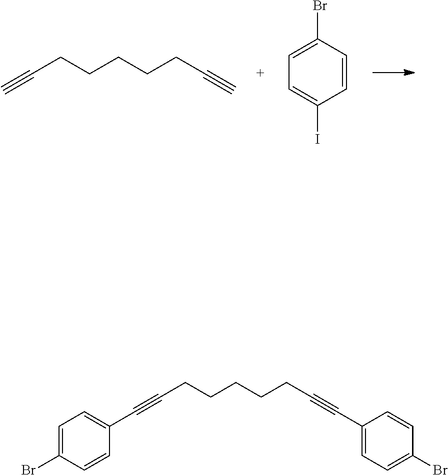

To a solution of 1-bromo-4-iodo-benzene (25.00 g; 88.37 mmol) in 80 mL tetrahydrofuran, bis(triphenylphosphine)palladium(II) dichloride (0.90 g; 1.28 mmol), copper(I) iodide (0.20 g; 1.05 mmol) and diisopropylamine (14.00 ml; 99.61 mmol) are added. The reaction mixture is purged with nitrogen. Then, nona-1,8-diyne (5.00 g; 41.60 mmol) in 20 mL tetrahydrofuran is added slowly. The reaction is stirred overnight at room temperature. Reaction mixture is filtered and the solid washed with tetrahydrofuran. The solvent is removed under reduced pressure. Column chromatography of crude on silica gel eluted with dichloromethane gives product as yellow solid.

Stage 2

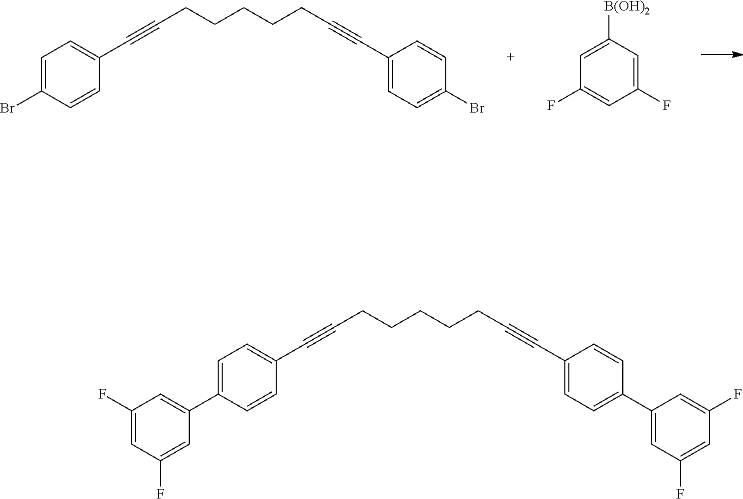 [SMILES: Brc1ccc(C#CCCCCCC#Cc2ccc(Br)cc2)cc1 ; OB(O)c1cc(F)cc(F)c1 ; Fc1cc(F)cc(-c2ccc(C#CCCCCCC#Cc3ccc(-c4cc(F)cc(F)c4)cc3)cc2)c1]

1-bromo-4-[9-(4-bromophenyl)nona-1,8-diynyl]benzene (30.00 g; 69.74 mmol), (3,5-difluorophenyl)boronic acid (24.23 g; 153.43 mmol), bis(triphenylphosphine)palladium(II) dichloride (2.45 g; 3.49 mmol) are charged into a flask containing 600 mL tetrahydrofuran. Aqueous solution of sodium carbonate (2 M, 139.48 ml; 278.96 mmol) is added. The reaction mixture is degassed and stirred at 80° C. overnight. Organic layer is separated, dried over magnesium sulphate and evaporated under reduced pressure. Column chromatography of crude on silica gel eluted with petroleum ether/dichloromethane (4:1 ratio) gives pure product.

Phase sequence: K 115 I, e/K=1.72 V⁻¹.

### Synthesis Example 2b

Preparation of

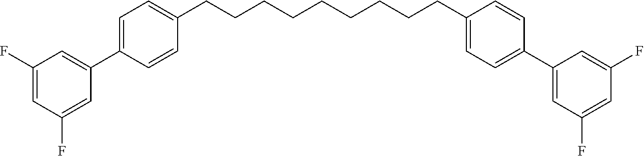 [SMILES: Fc1cc(F)cc(-c2ccc(CCCCCCCCCc3ccc(-c4cc(F)cc(F)c4)cc3)cc2)c1]

The compound of interest is prepared according to the following scheme.

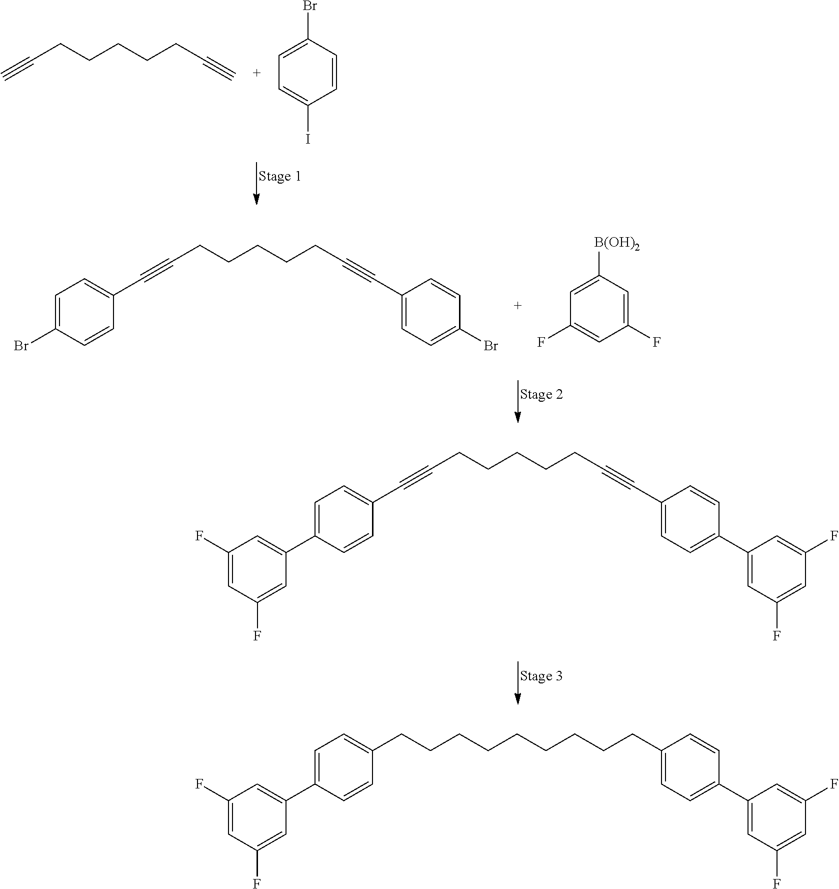

Stages 1 and 2 are carried out as in Example 2a.

Stage 3

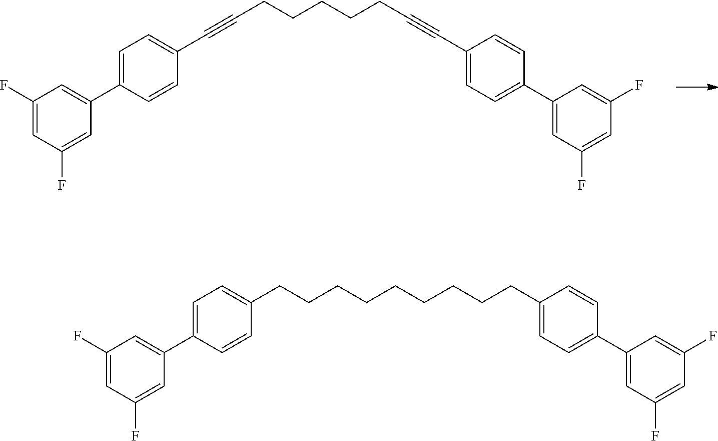 [SMILES: Fc1cc(F)cc(-c2ccc(C#CCCCCCC#Cc3ccc(-c4cc(F)cc(F)c4)cc3)cc2)c1 ; Fc1cc(F)cc(-c2ccc(CCCCCCCCCc3ccc(-c4cc(F)cc(F)c4)cc3)cc2)c1]

1-[4-[9-[4-(3,5-difluorophenyl)phenyl]nona-1,8-diynyl]phenyl]-3,5-difluoro-benzene (7.00 g; 1.00 eq.) in 100 mL methanol/tetrahydrofuran (1:1 ratio) is pumped four times through the H-Cube® using 10% Pd/C as catalyst. The pressure of the system is set to 10 bar, flow rate 10 mL/min and the temperature to 30° C. The solvent is removed under reduced pressure, affording the product as white crystals.

Phase sequence: K 46 I, e/K=2.0 V⁻¹.

### Synthesis Example 3

Preparation of

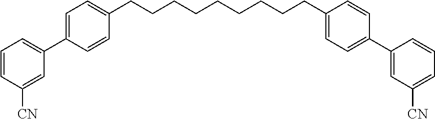 [SMILES: N#Cc1cccc(-c2ccc(CCCCCCCCCc3ccc(-c4cccc(C#N)c4)cc3)cc2)c1]

The compound of interest is prepared according to the following scheme.

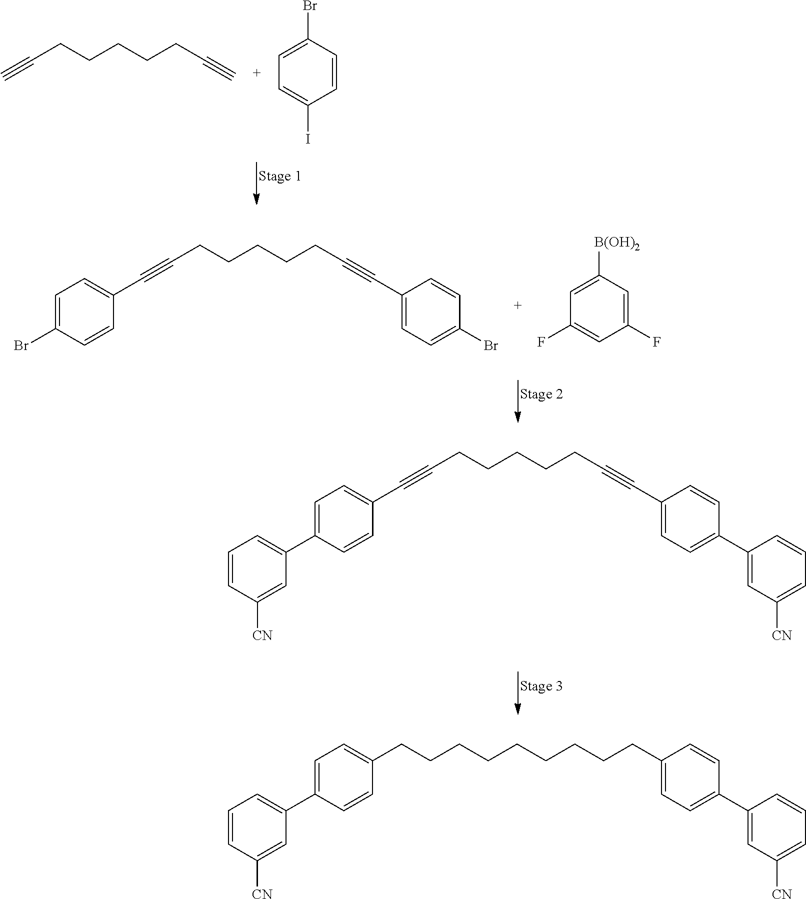

Stage 1 is carried out as in Example 2a.

Stage 2

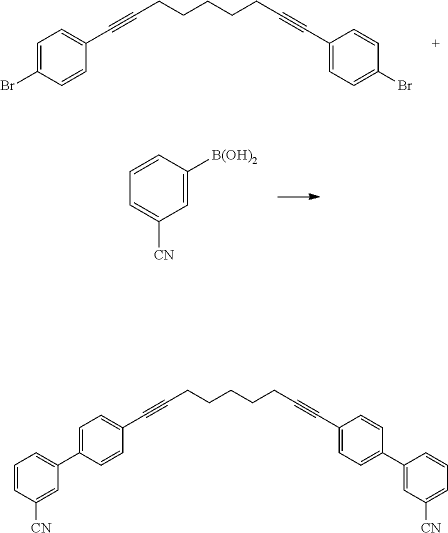 [SMILES: Brc1ccc(C#CCCCCCC#Cc2ccc(Br)cc2)cc1 ; N#Cc1cccc(B(O)O)c1 ; N#Cc1cccc(-c2ccc(C#CCCCCCC#Cc3ccc(-c4cccc(C#N)c4)cc3)cc2)c1]

1-Bromo-4-[9-(4-bromophenyl)nona-1,8-diynyl]benzene (8.00 g; 18.60 mmol) and (3-cyanophenyl)boronic acid (5.88 g; 40.00 mmol) are charged into a flask containing 1,4-dioxane (200.00 mL). [1,1′-Bis(diphenylphosphino)ferrocene]dichloropalladium(II), complex with dichloromethane (0.50 g; 0.68 mmol), sodium carbonate (10.60 g; 100.00 mmol) and water (50.00 mL) are added. The reaction mixture is degassed and stirred at 80° C. for 3 h. The reaction is cooled to room temperature and 100 mL ethyl acetate is added. Organic phase is separated, washed with brine then water, and evaporated under educed pressure. Column chromatography of crude on silica gel eluted with petroleum ether/dichloromethane (7:3 ratio) gives product.

Stage 3

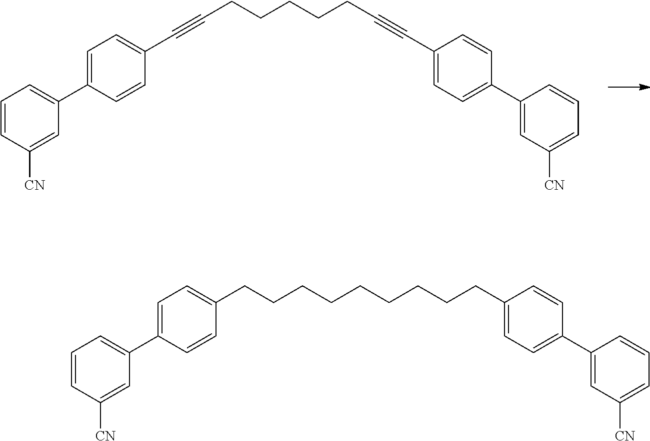 [SMILES: N#Cc1cccc(-c2ccc(C#CCCCCCC#Cc3ccc(-c4cccc(C#N)c4)cc3)cc2)c1 ; N#Cc1cccc(-c2ccc(CCCCCCCCCc3ccc(-c4cccc(C#N)c4)cc3)cc2)c1]

3-[4-[9-[4-(3-cyanophenyl)phenyl]nona-1,8-diynyl]phenyl]benzonitrile (1.50 g; 1.00 eq.) in 100 mL methanol is pumped through the H-Cube® using 10% Pd/C as catalyst. The pressure of the system is set to 30 bar, flow rate 3 mL/min, and the temperature to 30° C. The solvent is removed under reduced pressure. Crystallisation from acetonitrile gives pure product.

Phase sequence: K 84 I.

### Synthesis Example 4

Preparation of

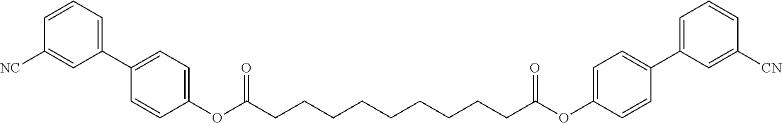 [SMILES: N#Cc1cccc(-c2ccc(OC(=O)CCCCCCCCCC(=O)Oc3ccc(-c4cccc(C#N)c4)cc3)cc2)c1]

The compound of interest is prepared according to the following scheme.

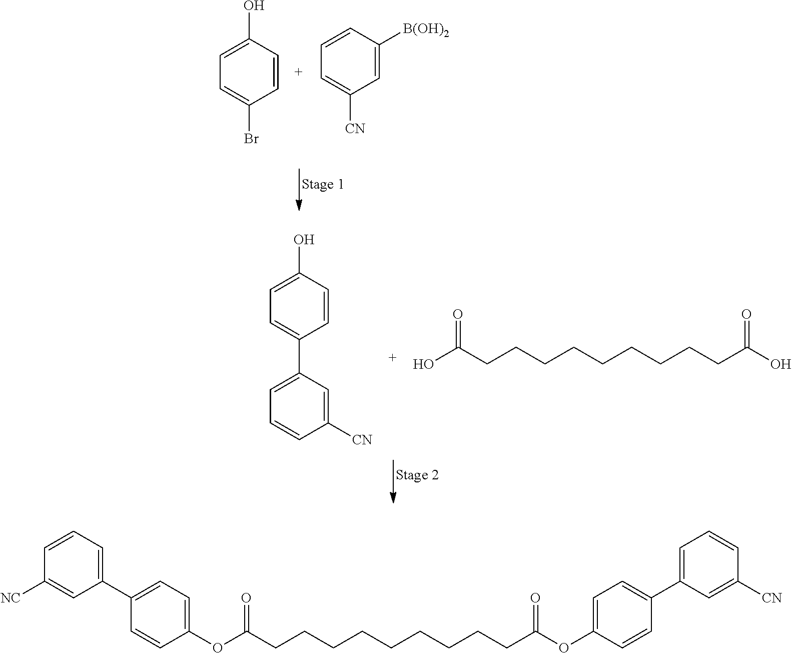

Stage 1

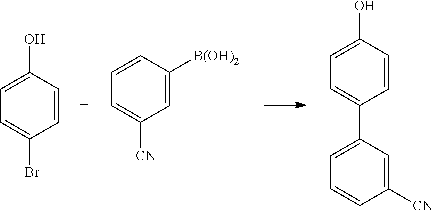 [SMILES: Oc1ccc(Br)cc1 ; N#Cc1cccc(B(O)O)c1 ; N#Cc1cccc(-c2ccc(O)cc2)c1]

4-Bromo-phenol (11.77 g; 68.05 mmol; 1.00 eq.), (3-cyanophenyl)boronic acid (10.00 g; 68.06 mmol) are charged to a flask containing 1,4-dioxane (200.00 mL). [1,1′-Bis(diphenylphosphino)ferrocene]dichloropalladium(II), complex with dichloromethane (0.50 g; 0.68 mmol), sodium carbonate (14.31 g; 0.14 mol) and water (50.00 mL) are added. The reaction mixture is degassed and stirred overnight at 80° C. Ethyl acetate (100 mL) is added. Organic phase is separated, washed with brine then water, dried over magnesium sulphate and evaporated under educed pressure. Recrystallisation from dichloromethane/ethyl acetate (1:4 ratio) gives product.

Stage 2

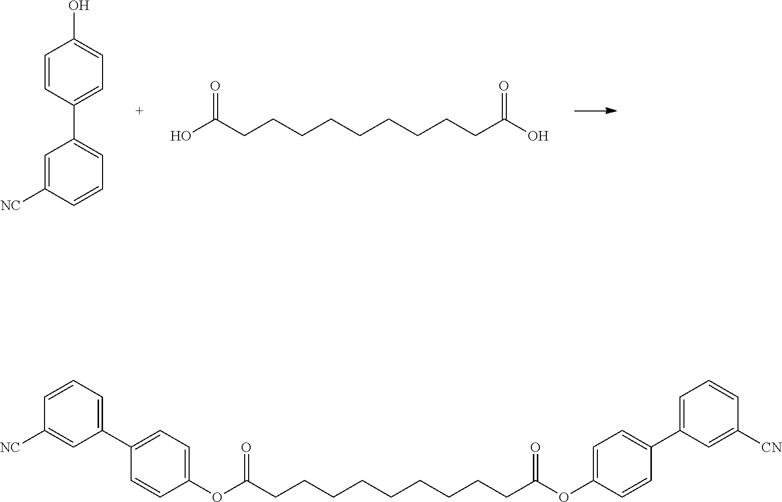 [SMILES: N#Cc1cccc(-c2ccc(O)cc2)c1 ; O=C(O)CCCCCCCCCC(=O)O ; N#Cc1cccc(-c2ccc(OC(=O)CCCCCCCCCC(=O)Oc3ccc(-c4cccc(C#N)c4)cc3)cc2)c1]

Undecanedioic acid (2.88 g; 13.30 mmol) acid is added to a flask containing 100 mL toluene. 4′-Hydroxy-biphenyl-3-carbonitrile (5.20 g; 26.64 mmol), N,N′-dicyclohexylcarbodiimid (5.57 g; 27.00 mmol) and 4-(dimethylamino)-pyridine (0.61 g; 5.00 mmol) are added and stirred overnight at room temperature. Water (50 mL) is added and organic phase is separated, dried over magnesium sulphate and evaporated under reduced pressure. Column chromatography of crude on silica gel eluted with petroleum ether/dichloromethane (3:2 ratio) followed by recrystallisation from petroleum ether/ethyl acetate gives pure product.

Phase sequence: K 125 (N 84) I, e/K=1.9 V⁻¹.

The above compounds have suitable phase behaviour and flexoelastic ratios and can be useful components in liquid crystal media as shown below, and can in particular be useful to tune the working temperature of high e/K mixtures with regard to the flexoelectric effect.

### Use Examples, Mixture Examples

Phase transitions, including clearing point, are initially measured using Differential Scanning Calorimetry (DSC).

Furthermore, typically a 5.6 μm thick cell having an anti-parallel rubbed PI alignment layer is filled on a hotplate at a temperature at which the flexoelectric mixture is in the isotropic phase.

After the cell has been filled phase transitions, including clearing point, are verified by optical inspection. For optical phase transition measurements, a Mettler FP90 hot-stage controller connected to a FP82 hot-stage is used to control the temperature of the cell. The temperature is increased from ambient temperature at a rate of 5° C. per minute until the onset of the isotropic phase is observed. The texture change is observed through crossed polarizers using an Olympus BX51 microscope and the respective temperature is noted.

Wires are then attached to the ITO electrodes of the cell using indium metal. The cell is secured in a Linkam THMS600 hot-stage connected to a Linkam TMS93 hot-stage controller. The hot-stage is secured to a rotation stage in an Olympus BX51 microscope.

The cell is heated until the liquid crystal is completely isotropic. The cell is then cooled under an applied electric field until the sample is completely nematic. The driving waveform is supplied by a Tektronix AFG3021B arbitrary function generator, which is sent through a Newtons4th LPA400 power amplifier before being applied to the cell. The cell response is monitored with a Thorlabs PDA55 photodiode. Both input waveforms and optical response are measured using a Tektronix TDS 2024B digital oscilloscope.

In order to measure the flexoelastic response of the material, the change in the size of the tilt of the optical axis is measured as a function of increasing voltage. In this connection the following equation is used

$$tan ϕ = \frac{{P}_{0}}{2 π} \frac{e}{K} \underline{E}$$

wherein φ is the tilt in the optical axis from the original position (i.e. when E=0), E is the applied field, K is the elastic constant (average of K₁ and K₃) and e is the flexoelectric coefficient, wherein e=e₁+e₃. The applied field is monitored using a HP 34401A multimeter. The tilt angle is measured using the aforementioned microscope and oscilloscope. The undisturbed cholesteric pitch, P₀, is measured using an Ocean Optics USB4000 spectrometer attached to a computer. The selective reflection band is obtained and the pitch is determined from the spectral data.

The mixtures according to the invention shown in the following examples are well suitable for use in flexoelectric displays. To achieve a suitable cholesteric pitch appropriate concentrations of chiral dopant or dopants can be used.

### Reference Mixture Example 1

The host mixture H-0 is prepared and investigated, inter alia studying its properties for alignment.

Composition
Compound

| No. | Abbreviation | Conc./% |
|---|---|---|
| 1 | F-PGI-O-9-O-GP-F | 25.0 |
| 2 | F-PGI-O-9-O-PP-N | 25.0 |
| 3 | F-PGI-ZI-9-Z-GP-F | 25.0 |
| 4 | F-PGI-ZI-9-Z-PP-N | 25.0 |
| Σ | | 100.0 |

The alignment of the mixtures is determined in a test cell with anti-parallel rubbed PI orientation layers, for planar alignment, having a cell gap of 10 μm at a wavelength of 550 nm. The optical retardation of the samples is determined using an ellipsometer instrument for various angles of incidence ranging from −60° to +40°.

The results for H-0 are compiled in the following table, wherein the sample H-0 shows an optical retardation of 25 nm under perpendicular observation, i.e. at an angle of incidence of 0°. This already indicates the presence of a homogeneous alignment. For various angles of incidence the values of the retardation range from 2 nm to 55 nm. Although scattering, as a function of the angle of incidence, is quite significant, there appears to be a trend for the retardation to increase with increasing angle of incidence. However, the significant scatter of the retardation values indicates a rather poor quality of the homeotropic alignment.

| | Angle/° | −60 | −40 | −20 | 0 | 20 | 40 |
|---|---|---|---|---|---|---|---|
| Mixt. | d · Δn/nm | 2 | 33 | 42 | 25 | 55 | 44 |
| H-0 | | | | | | | |

### Comparative Mixture Example 1

Mixture C-1

2% of the chiral dopant R-5011 are added in the mixture H-0 giving the mixture C-1, which is investigated for its properties.

Composition
Compound

| No. | Abbreviation | Conc./% |
|---|---|---|
| 1 | R-5011 | 2.0 |
| 2 | F-PGI-O-9-O-GP-F | 24.5 |
| 3 | F-PGI-O-9-O-PP-N | 24.5 |
| 4 | F-PGI-ZI-9-Z-GP-F | 24.5 |
| 5 | F-PGI-ZI-9-Z-PP-N | 24.5 |
| Σ | | 100.0 |

The mixture C-1 may be used for the USH mode. It has a clearing point of 82° C. and a lower transition temperature [T(N2,N)] of 33° C. It has a cholesteric pitch of 301 nm at 35° C. The e/K of this mixture is 1.9 Cm⁻¹N⁻¹ at a temperature of 34.8° C.

### Mixture Example 1

In a mixture of H-0 10% of the compound of Synthesis Example 1 and 2% of chiral dopant are comprised to give mixture M-1, which is investigated.

Composition
Compound

| No. | Abbreviation | Conc./% |
|---|---|---|
| 1 | R-5011 | 2.0 |
| 2 | F-PGI-O-9-O-GP-F | 22.0 |
| 3 | F-PGI-O-9-O-PP-N | 22.0 |
| 4 | F-PGI-ZI-9-Z-GP-F | 22.0 |
| 5 | F-PGI-ZI-9-Z-PP-N | 22.0 |
| 6 | Compound 1* | 10.0 |
| Σ | | 100.0 |

Remark: *) Compound of Synthesis Example 1.

This mixture M-1 is well suitable for the USH mode.

It has a cholesteric pitch of 307 nm at 40.2° C.

The e/K of this mixture is 1.96 Cm⁻¹ N⁻¹ at a temperature of 39.3° C.

### Mixture Example 2

In a mixture of H-0 10% of the compound of Synthesis Example 2a and 2% of dopant are comprised to give mixture M-2, which is investigated.

Composition
Compound

| No. | Abbreviation | Conc./% |
|---|---|---|
| 1 | R-5011 | 2.0 |
| 2 | F-PGI-O-9-O-GP-F | 22.0 |
| 3 | F-PGI-O-9-O-PP-N | 22.0 |
| 4 | F-PGI-ZI-9-Z-GP-F | 22.0 |
| 5 | F-PGI-ZI-9-Z-PP-N | 22.0 |
| 6 | Compound 2a* | 10.0 |
| Σ | | 100.0 |

Remark: *) Compound of Synthesis Example 2a.

This mixture M-2 is well suitable for the USH mode. It has a cholesteric pitch of 311 nm at 40° C. The e/K of this mixture is 1.72 Cm⁻¹N⁻¹ at a temperature of 39.3° C.

### Mixture Example 3

In a mixture of H-0 10% of the compound of Synthesis Example 2b and 2% of chiral dopant are comprised to give mixture M-3, which is investigated.

Composition
Compound

| No. | Abbreviation | Conc./% |
|---|---|---|
| 1 | R-5011 | 2.0 |
| 2 | F-PGI-O-9-O-GP-F | 22.0 |
| 3 | F-PGI-O-9-O-PP-N | 22.0 |
| 4 | F-PGI-ZI-9-Z-GP-F | 22.0 |
| 5 | F-PGI-ZI-9-Z-PP-N | 22.0 |
| 6 | Compound 2b* | 10.0 |
| Σ | | 100.0 |

Remark: *) Compound of Synthesis Example 2b.

This mixture M-3 is well suitable for the USH mode. It has a cholesteric pitch of 277 nm at 35° C. The e/K of this mixture is 2.00 Cm⁻¹N⁻¹ at a temperature of 36.6° C.

1. A bimesogenic compound of formula I 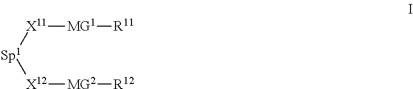
wherein
R¹¹ and R¹² respectively and independently denote a terminal group selected from H, F, Cl, CN, NCS and a straight-chain or branched alkyl group with 1 to 25 C atoms, said alkyl group optionally being substituted by one or more halogen and/or CN groups and optionally having one or more CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another,
MG¹ and MG² respectively and independently denote a mesogenic group comprising one or more cyclic groups selected from aromatic, heteroaromatic, non-aromatic carbocyclic and/or non-aromatic heterocyclic groups, which are connected to each other directly and/or via (a) linking group(s),
wherein the respective terminal group R¹¹ or R¹² is directly linked to a cyclic group of the mesogenic group,
Sp¹ denotes alkylene having 1, 3 or 5 to 40 C atoms, wherein
optionally one or more CH₂ groups are, respectively and independently, replaced by —O—, —S—, —NH—, —N(CH₃)—, —CO—, —CO—O—, —O—CO—, —O—COO—, —CO—S—, —S—CO—, —CH(halogen)-, —CH(CN)—, —CH═CH— or —C≡C—,
wherein respectively two O atoms, two —CH═CH— groups and two groups selected from —O—CO—, —S—CO—, —O—COO—, —CO—S— and —CO—O— are not linked directly to one another, and
X¹¹ and X¹² are independently from one another selected from a single bond, —CO—O—, —O—CO—, —O—COO—, —O—, —CH═CH—, —C≡C—, —CF₂—O—, —O—CF₂—, —CF₂—CF₂, —CH₂—O—, —O—CH₂—, —CO—S—, —S—CO—, —CS—S—, —S—CS—, —S—CSS— and —S—,
wherein in —X¹¹-Sp¹-X¹²— respectively two O atoms, two —CH═CH— groups and two groups selected from —O—CO—, —S—CO—, —O—COO—, —CO—S— and —CO—O— are not linked directly to one another,
provided that at least one of R¹¹ and R¹² is H,
or
provided that at least one of R¹¹ and R¹² is a straight-chain or branched alkyl group with 1 to 25 C atoms, said alkyl group optionally being substituted by one or more halogen and/or CN groups and optionally having one or more CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another, and further at least one of MG¹ and MG² exhibits in addition to the terminal group one or more substituents respectively and independently selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups.

2. The bimesogenic compound according to claim 1, wherein MG¹ and MG² respectively and independently comprise at least one 6-atomic ring and optionally one, two or more 5-atomic rings, wherein in case of comprising two or more rings at least two of these rings are optionally linked by a 2-atomic linking group, preferably selected from —CO—O—, —O—CO—, —CH₂—O—, —O—CH₂—, —CF₂—O—, —O—CF₂—, —CH₂CH₂—, —CF₂CF₂—, —CH═CH—, —CF═CF— and —C≡C—, more preferably —CO—O—, —O—CO—, —CH₂—O—, —O—CH₂—, —CF₂—O— and —O—CF₂—,
and wherein in MG¹ and MG² the respective cyclic groups directly connected to the respective terminal groups are respectively and independently 1,4-phenylene, wherein optionally one or two non-adjacent CH groups each may be replaced by an N atom, and which optionally is substituted by one or more substituents respectively and independently selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups, and/or by one or more alkyl groups each independently having 1 to 9 C atoms and/or by one or more alkoxy groups each independently having 1 to 9 C atoms,
or 1,4-cyclohexylene, wherein optionally one or two non-adjacent CH₂ groups are replaced by O and/or S, and which optionally is substituted by one or more substituents respectively and independently selected from F, Cl, CN, NCS, OCF₃, CF₃, SCH₃, NO₂, NH₂, NHR^{c} and NR^{c}R^{d}, wherein R^{c} and R^{d} each independently denote a straight-chain or branched alkyl group with 1 to 6 C atoms, said alkyl group optionally being substituted by one or more halogen and/or CN groups and/or by one or more alkyl groups each independently having 1 to 9 C atoms and/or by one or more alkoxy groups each independently having 1 to 9 C atoms.

3. The bimesogenic compound according to claim 1, wherein at least one of MG¹ and MG² comprises a cyclic group selected from the structures represented by 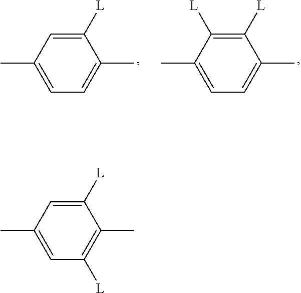
and the mirror images thereof,
wherein L, in each occurrence independently from one another, denotes F, Cl, CN, NCS, OCF₃, CF₃, SCH₃, NO₂, NH₂, NHR^{c} and NR^{c}R^{d}, wherein R^{c} and R^{d} each independently are a straight-chain or branched alkyl group with 1 to 6 C atoms, said alkyl group optionally being substituted by one or more halogen and/or CN groups.

4. The bimesogenic compound according to claim 1, comprising one of the structures represented by 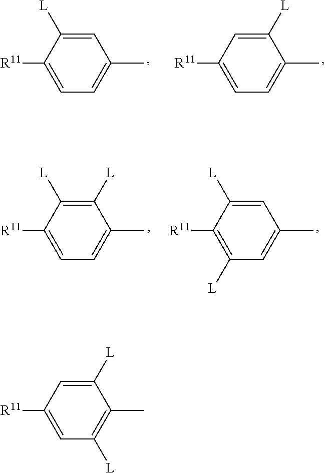
wherein R¹¹ denotes a terminal group selected from H, F, Cl CN, NCS and a straight-chain or branched alkyl group with 1 to 25 C atoms, said alkyl group optionally being substituted by one or more halogen and/or CN groups and optionally having one or more CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another, and L in each occurrence independently from one another, denotes F, Cl, CN, NCS, OCF₃, CF₃, SCH₃, NO₂, NH₂, NHR^{c} and NR^{c}R^{d}, wherein R^{c} and R^{d} each independently are a straight-chain or branched alkyl group with 1 to 6 C atoms, said alkyl group optionally being substituted by one or more halogen and/or CN groups, and wherein optionally R¹¹ can be replaced by R¹².

5. The bimesogenic compound according to claim 1, wherein at least one of MG¹ and MG² comprises a cyclic group selected from the structures represented by 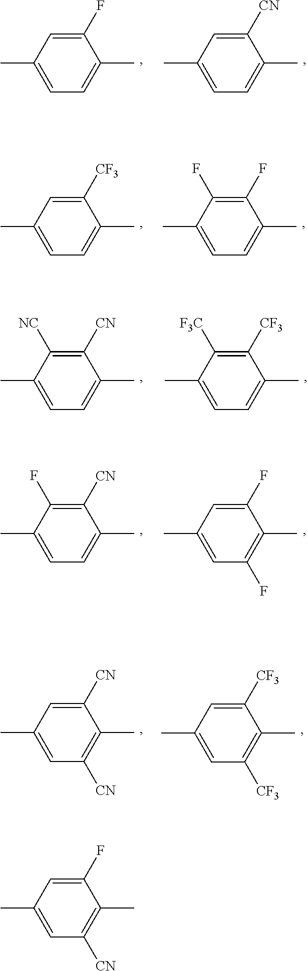
and the mirror images thereof,
wherein preferably said cyclic group is directly connected to the respective terminal group R¹¹ or R¹².

6. The bimesogenic compound according to claim 1, wherein at least one of R¹¹ and R¹² is H, preferably R¹¹ and R¹² are H.

7. The bimesogenic compound according to claim 1, wherein at least one of R¹¹ and R¹² is a straight-chain or branched alkyl group with 1 to 25 C atoms, said alkyl group optionally being substituted by one or more halogen and/or CN groups and optionally having one or more CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another, preferably R¹¹ and R¹², in each occurrence independently from one another, denote a straight-chain or branched alkyl group with 1 to 25 C atoms, said alkyl group optionally being substituted by one or more halogen and/or CN groups and optionally having one or more CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another.

8. The bimesogenic compound according to claim 1, wherein Sp¹ is —(CH₂)ₖ—, wherein k is 1, 3 or an integer from 5 to 15.

9. (canceled)

10. A liquid crystalline medium comprising one or more bimesogenic compounds according to claim 1.

11. The liquid crystalline medium according to claim 10, additionally comprising a chiral dopant.

12. The liquid crystalline medium according to claim 10,
additionally comprising one or more compounds selected from the group of the compounds of formula II
R²¹-MG²¹-X²¹—Sp²-X²²MG²²-R²² II
wherein
R²¹ and R²² are each independently H, F, Cl, CN, NCS or a straight-chain or branched alkyl group with 1 to 25 C atoms, said alkyl group optionally being substituted by one or more halogen and/or CN groups and optionally having one or more non-adjacent CH₂ groups replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C—,
MG²¹ and MG²² are each independently a mesogenic group,
Sp² is a spacer group comprising 5 to 40 C atoms, wherein one or more non-adjacent CH₂ groups may be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—, and
X²¹ and X²² are each independently —O—, —S—, —CO—, —COO—, —OCO—, —O—CO—O—, —CO—NH—, —NH—CO—, —CH₂CH₂—, —OCH₂—, —CH₂O—, —SCH₂—, —CH₂S—, —CH═CH—, —CH═CH—COO—, —OCO—CH═CH—, —C≡C— or a single bond, provided that the compounds of formula I are excluded from the compounds of formula II.

13. (canceled)

14. A liquid crystal device comprising a liquid crystalline medium which comprises two or more components, wherein at least one of the components is the bimesogenic compound according to claim 1.

15. The liquid crystal device according to claim 14, wherein the device is a flexoelectric device.
